(19) United States
(12) Patent Application Publication
(10) Pub. No.: US 2008/0136752 A1
(43) Pub. Date: Jun. 12, 2008

(54) Image Display Apparatus, Image Display Monitor and Television Receiver

(75) Inventors: Akihiko Inoue, Kyoto (JP); Takeshi Kumakura, Nara (JP)

Correspondence Address: HARNESS, DICKEY & PIERCE, P.L.C., P.O. BOX 8910, RESTON, VA, 20195, US

(73) Assignee: SHARP KABUSHIKI KAISHA, OSAKA JAPAN (JP)

(21) Appl. No.: 11/794,948

(22) PCT Filed: Mar. 7, 2006
(86) PCT No.: PCT/JP06/04396

§ 371 Date: Jul. 10, 2007

(30) Foreign Application Priority Data
Mar. 18, 2005 (JP) 2005-080571

(51) Int. Cl. G09G 3/36; H04N 5/44; G09G 3/30

(52) U.S. Cl. 345/77; 345/89; 348/725; 348/E05.096

(57) ABSTRACT

A control LSI (30) time-divides one frame period of an input image signal into a plurality of sub-frame periods and outputs the signal to a display panel, so as to carry out image display by pseudo impulse driving. At this time, in a first display mode, a first tone converting circuit (34) refers to a first table (37), and a second tone converting circuit (35) refers to a third table (39), to generate an image signal of each sub-frame from the input image signal. In a second display mode, the first tone converting circuit (34) refers to a second table (38), and the second tone converting circuit (35) refers to a fourth table (40), to generate the image signal of the sub-frame from the input image signal. Each of a first selector (41) and a second selector (42) switches the tables to be referred in accordance with a mode switching signal. Thus, it is possible to realize an image display apparatus which can effectively obtain an effect of suppressing an unfocused moving image by the pseudo impulse driving and reduce the problem of the flicker caused by the pseudo impulse driving.

### TECHNICAL FIELD

The present invention relates to an image display apparatus which use a hold display element, such as a liquid crystal display element or an EL (Electro Luminescence) display element.

### BACKGROUND ART

In recent years, in addition to CRT (Cathode Ray Tube) display apparatuses, various display apparatuses, such as liquid crystal display apparatuses, plasma display apparatuses and organic EL display apparatuses, have been developed and commercialized.

In display apparatuses, such as the CRT display apparatuses, which carry out impulse display (display carried out only during a light emitting period), pixels during a non-selected period carry out black display. Meanwhile, in hold display (display of keeping holding an image of a previous frame until a new image is written) apparatuses, such as the liquid crystal display apparatuses and the organic EL display apparatuses, the pixels during the non-selected period keeps the content of the display written previously (normal display of the hold display apparatus).

In the normal display of the hold display apparatus, a problem of an unfocused moving image occurs when displaying a moving image. The problem of the unfocused moving image occurs since the content of the display is kept in the pixels of the hold display apparatus even during its non-selected period. This problem is not solved even if a response speed of the pixel is improved.

One method for preventing the unfocused moving image of the hold display apparatus is to carry out time-division driving. Note that the time-division driving is a driving method for dividing one vertical period (one frame) into a plurality of sub-frames, and writing a signal to each pixel more than once.

That is, if the hold display apparatus carries out the time-division driving and carries out low luminance display (display close to black display) in at least one of sub-frames, it can carry out pseudo display similar to the impulse display, and this is effective for preventing the unfocused moving image.

For example, Document 1 discloses the time-division driving of the liquid crystal display apparatus.

[Document 1] Japanese Unexamined Patent Publication No. 296841/2001 (Tokukai 2001-296841 (published on Oct. 26, 2001))

[Document 2] Japanese Unexamined Patent Publication No. 184034/2001 (Tokukai 2001-184034 (published on Jul. 6, 2001))

[Document 3] Japanese Unexamined Patent Publication No. 262846/2003 (Tokukai 2003-262846 (published on Sep. 19, 2003))

### DISCLOSURE OF INVENTION

However, when the display apparatus which uses the hold display element carries out the above pseudo impulse driving to improve the performance of the moving image, the problem is that flicker tends to occur (this problem is caused also by the increase in luminance and size of the screens of the recent display apparatuses). The flicker becomes especially significant when, for example, a frame frequency is low or display luminance is high, and this makes a user's eye tired.

The present invention was made to solve the above problems, and an object of the present invention is to realize an image display apparatus which can effectively obtain an effect of suppressing the unfocused moving image by the pseudo impulse driving and reduce the problem of the flicker caused due to the pseudo impulse driving.

In order to solve the above problems, an image display apparatus of the present invention divides one frame period of an input image signal into a plurality of sub-frame periods so as to carry out image display, the image display apparatus including a plurality of distributing means for distributing luminance to respective sub-frames so that a total of time integral values of luminance of the respective sub-frames in said one frame period reproduces luminance of said one frame period based on the input image signal, and among the plurality of distributing means, a luminance distribution ratio for the sub-frames is different, and switching among the plurality of distributing means is carried out.

Moreover, the image display apparatus further includes switching means for switching among the plurality of distributing means.

In the image display apparatus which carries out the above time-division driving, the display luminance is distributed to respective sub-frames so that the time integral values of the display luminance of the respective sub-frames reproduce a tone luminance characteristic in one frame period based on the input image signal. By this distribution of the display luminance to the sub-frames, a high luminance sub-frame(s) and a low luminance sub-frame(s) are produced. Because of this, the time-division driving display becomes the pseudo impulse display and achieves the effect of suppressing the unfocused moving image. The degree of this effect changes depending on the luminance distribution ratio. That is, if the distribution ratio is set such that the difference of luminance between the sub-frames is large, the effect of suppressing the unfocused moving image is large, and if the distribution ratio is set such that the difference of luminance between the sub-frames is small, the effect of suppressing the unfocused moving image is small.

Although the effect of suppressing the unfocused moving image can be obtained by carrying out the time-division driving, another problem is that the flicker tends to occur. The flicker tends to occur more often when the distribution ratio is set such that the difference of luminance between the sub-frames is large, and the flicker tends to occur less often when the distribution ratio is set such that the difference of luminance between the sub-frames is small.

According to the above arrangement, a plurality of distributing means are included, the luminance distribution ratio for the sub-frames is different among the plurality of distributing means, and the plurality of distributing means can be used while being switched among them. Therefore, in the case of trying to suppress the unfocused moving image, it is possible to carry out the luminance distribution for the sub-frames by using the distributing means which has the high effect of suppressing the unfocused moving image, and in the case of trying to suppress the flicker, it is possible to carry out the luminance distribution for the sub-frames by using the distributing means which hardly causes the flicker. Thus, it is possible to effectively obtain the effect of suppressing the unfocused moving image by the pseudo impulse driving, and also possible to reduce the problem of the flicker caused due to the pseudo impulse driving.

As above, the image display apparatus of the present invention includes a plurality of distributing means each of which distributes the display luminance to respective sub-frames so that the time integral values of the display luminance of the respective sub-frames in one frame period reproduce the luminance in one frame period based on the input image signal, the luminance distribution ratio for the sub-frames is different among the plurality of distributing means, and the image display apparatus includes switching means for switching among the plurality of distributing means.

Therefore, the plurality of distributing means each of which has a different luminance distribution ratio for the sub-frames can be used while being switched among them by the switching means, and in the case of trying to suppress the unfocused moving image, it is possible to carry out the luminance distribution for the sub-frames by using the distributing means which has the high effect of suppressing the unfocused moving image, and in the case of trying to suppress the flicker, it is possible to carry out the luminance distribution for the sub-frames by using the distributing means which hardly causes the flicker. Thus, it is possible to effectively obtain the effect of suppressing the unfocused moving image by the pseudo impulse driving, and also possible to reduce the problem of the flicker caused due to the pseudo impulse driving.

### BRIEF DESCRIPTION OF DRAWINGS

FIG. 1 shows an embodiment of the present invention and is a block diagram showing a schematic arrangement of a control LSI of Embodiment 1.

FIG. 2 is a block diagram showing a schematic arrangement of an image display apparatus of Embodiment 1.

FIG. 3 is a diagram showing a luminance distribution in a first display mode in the image display apparatus.

FIG. 4 is a diagram showing the luminance distribution in a second display mode in the image display apparatus.

FIG. 5 is a diagram showing an operation in the image display apparatus.

FIG. 6 is a block diagram showing a schematic arrangement of the image display apparatus of Embodiment 2.

FIG. 7 is a block diagram showing a schematic arrangement of the control LSI of Embodiment 2.

FIG. 8 is a block diagram showing a schematic arrangement of the control LSI of Embodiment 3.

FIG. 9 is a block diagram showing a schematic arrangement of the control LSI of Embodiment 4.

FIG. 10 is a block diagram showing a schematic arrangement of the image display apparatus of Embodiment 5.

FIG. 11 is a block diagram showing a schematic arrangement of the control LSI of Embodiment 7.

FIG. 12 is a diagram showing an example in which a display screen image is divided into a plurality of block areas.

FIG. 13 is a block diagram showing a schematic arrangement of a per-area determining circuit of Embodiment 7.

FIG. 14(a) is a diagram showing an example of the block area determined as a moving image area.

FIG. 14(b) is a diagram showing an example of the block area determined as a still image area.

FIG. 15 is a diagram showing a modification example of a method for determining the moving image area and the still image area.

FIG. 16 is a block diagram showing a schematic arrangement of the per-area determining circuit of Embodiment 7.

FIG. 17 is a graph showing a distribution ratio for a first-half sub-frame and a second-half sub-frame with respect to an input image signal tone level in the luminance distributions shown in Tables 3 to 5.

FIG. 18 is a graph showing visible luminance (front luminance) from the front and visible luminance (oblique luminance) at an oblique angle of 60° in the case of display by the luminance distributions shown in Tables 3 to 5.

### REFERENCE NUMERALS

1, 2, 3 IMAGE DISPLAY APPARATUS
20 FRAME MEMORY
30, 60, 70, 80, 90
   CONTROL LSI
31 LINE BUFFER
32 TIMING CONTROLLER
33 FRAME MEMORY DATA SELECTOR
34 FIRST TONE CONVERTING CIRCUIT
35 SECOND TONE CONVERTING CIRCUIT
36 OUTPUT DATA SELECTOR
37 FIRST LUT (FIRST DISTRIBUTING MEANS)
38 SECOND LUT (FIRST DISTRIBUTING MEANS)
39 THIRD LUT (SECOND DISTRIBUTING MEANS)
40 FOURTH LUT (SECOND DISTRIBUTING MEANS)
41 FIRST SELECTOR (FIRST DISTRIBUTING MEANS)
42 SECOND SELECTOR (SECOND DISTRIBUTING MEANS)
50 MODE SELECTOR SWITCH (SWITCHING MEANS)
51 IMAGE SOURCE SELECTOR SWITCH (IMAGE SOURCE DETERMINING MEANS, SWITCHING MEANS)
61 MOVING/STILL IMAGE DETERMINING CIRCUIT (DETERMINING MEANS, MOVING/STILL IMAGE DETERMINING MEANS, SWITCHING MEANS)
71 LUMINANCE MEASURING CIRCUIT DETERMINING MEANS, LUMINANCE MEASURING MEANS, SWITCHING MEANS)
81 FRAME FREQUENCY MEASURING CIRCUIT (DETERMINING MEANS, FRAME FREQUENCY MEASURING MEANS, SWITCHING MEANS)
91 PER-AREA DETERMINING CIRCUIT (DETERMINING MEANS, MOVING/STILL IMAGE DETERMINING MEANS, SWITCHING MEANS)
91′ PER-AREA DETERMINING CIRCUIT (DETERMINING MEANS, LUMINANCE MEASURING MEANS, SWITCHING MEANS)

### BEST MODE FOR CARRYING OUT THE INVENTION

### Embodiment 1

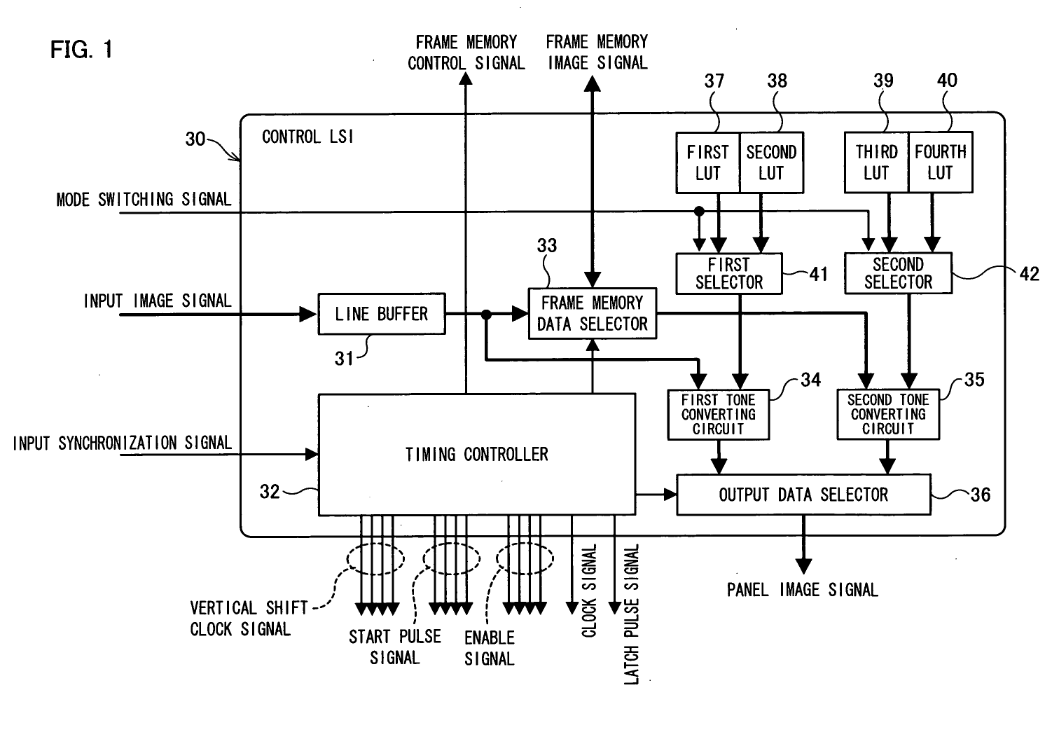

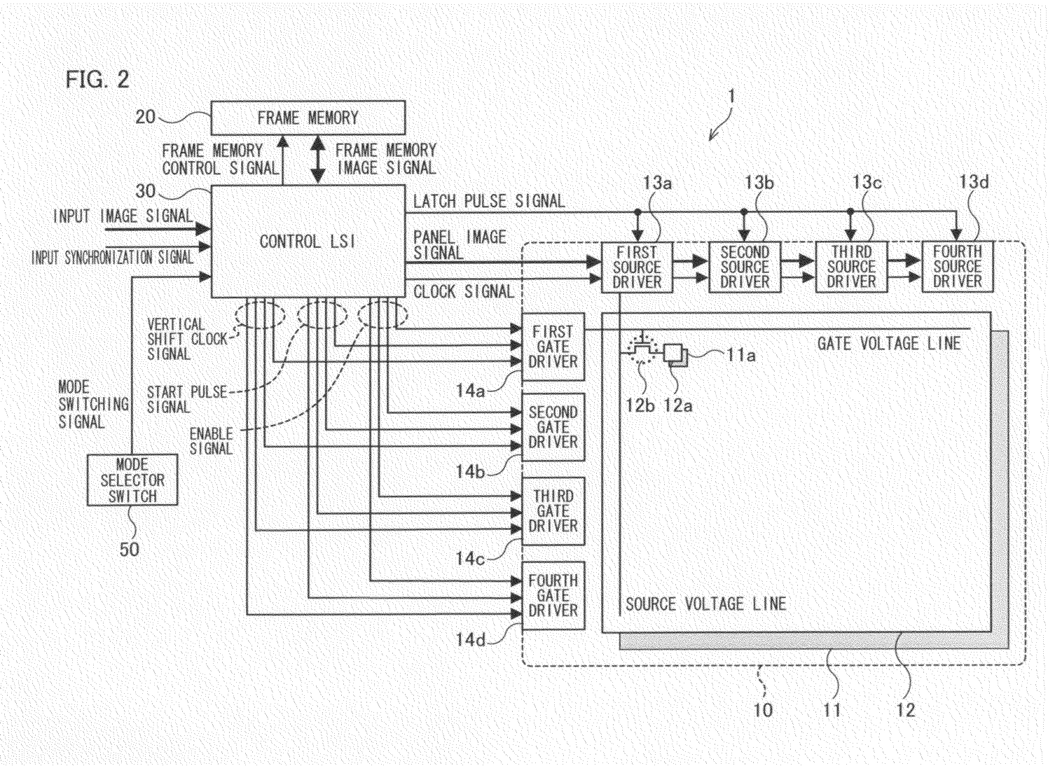

The following will explain one embodiment of the present invention on the basis of FIGS. 1 to 5. First explained below is a schematic arrangement of an image display apparatus of the present embodiment 1 in reference to FIG. 2. In FIG. 2, an image display apparatus 1 includes a display panel 10, a frame memory 20, a control LSI 30 and a mode selector switch 50.

The display panel 10 constitutes image displaying means, and includes a display element array 11, a TFT substrate 12, source drivers 13a to 13d, and gate drivers 14a to 14d. In the display element array 11, a plurality of display elements 11a (pixel portions), such as liquid crystal materials or organic EL members, are arranged in a matrix manner.

In a display area of the TFT substrate 12, (i) pixel electrodes 12a which drives the display elements 11a, and (ii) TFTs 12b that are switching elements which turn on or off electric charge supply (display voltage) to the pixel electrodes 12a are respectively arranged in a matrix manner so that they respectively correspond to the display elements 11a. At peripheral portions of the display element array 11 and the display area of the TFT substrate 12, the source drivers and the gate drivers are provided to drive the pixel electrodes 12a and the display elements 11a via the TFTs 12b. Regarding the source drivers, FIG. 2 shows an example of an arrangement in which the first to fourth source drivers 13a to 13d are cascaded. Regarding the gate drivers, FIG. 2 shows an example of an arrangement in which the first to fourth gate drivers 14a to 14d are cascaded.

In the display area of the TFT substrate 12, (i) a plurality of source voltage lines which are connected to the source drivers and to which source voltages (display voltages) are supplied and (ii) a plurality of gate voltage lines which are connected to the gate drivers and to which gate voltages (scanning signal voltages) are supplied are arranged so as to cross each other. In the vicinity of each intersection, the pixel electrode 12a and the TFT 12b are provided.

A gate electrode of the TFT 12b is connected to the corresponding gate voltage line (the gate voltage line at its intersection), a source electrode of the TFT 12b is connected to the corresponding source voltage line (the source voltage line at its intersection), and a drain electrode of the TFT 12b is connected to the pixel electrode 12a.

The frame memory 20 stores image signals of one frame, the image signals being to be displayed on the display panel 10. The control LSI 30 is display control means for controlling respective members. The mode selector switch 50 outputs a mode switching signal to the control LSI 30 in accordance with a user's operation so that a display mode can be switched in accordance with a user's instruction.

The following will explain a basic image displaying method of the image display apparatus 1 arranged as above.

First, the control LSI 30 sequentially transfers panel image signals, to be displayed on the pixel portions of one horizontal line, to the first source driver 13a in sync with clock signals. Since the first to fourth source drivers 13a to 13d are cascaded as shown in FIG. 2, the panel image signals for the pixels of one horizontal line are once held in the first to fourth source drivers 13a to 13d by pulses of the clock signals which pulses correspond in number to the pixels of one horizontal line. In this state, when the control LSI 30 outputs latch pulse signals to the first to fourth source drivers 13a to 13d, the source driver 13a to 13d output display voltage levels, corresponding to the image signals of the respective pixel portions, to the source voltage lines for the pixels of one horizontal line.

The control LSI 30 outputs, as control signals to each of the gate drivers 14a to 14d, an enable signal, a start pulse signal and a vertical shift clock signal. When the enable signal is a low level, the gate voltage line is in an OFF state. Moreover, when the enable signal is a high level, and the start pulse signal is supplied, a first gate voltage line of the relevant gate driver becomes an ON state at a timing of a rising edge of the vertical shift clock signal. Moreover, when the enable signal is the high level, and the start pulse signal is not supplied, the next gate voltage line of the gate voltage line which has previously become an ON state becomes an ON state at the timing of the rising edge of the vertical shift clock signal.

When one gate voltage line becomes an On state in a period during which the display voltages for the pixels of one horizontal line are supplied to the above source voltage lines, the TFTs 12b, connected to this gate voltage line, for the pixels of one horizontal line become an ON state. Thus, electric charges (display voltages) are supplied from the source voltage lines to the pixel electrodes 12a for the pixels of one horizontal line, this changes the states of the display elements 11a, and image display is carried out. The above display control is repeatedly carried out for each horizontal line, so that the image display is carried out on the entire display screen.

Objects of the image display apparatus 1 of the present embodiment 1 are to effectively obtain an effect of suppressing the unfocused moving image by the pseudo impulse driving and reduce the problem of the flicker caused due to the pseudo impulse driving. To achieve these objects, the image display apparatus 1 of the present embodiment 1 has a feature of carrying out switching of the display mode in accordance with the content of the displayed image. The following will explain this feature in detail.

As an example, the image display apparatus 1 is arranged so that the switching of the display mode is carried out on the basis of the user's instruction input by the mode selector switch 50. That is, when the user operates the mode selector switch 50 to switch the display mode, the mode switching signal is supplied from the mode selector switch 50 to the control LSI 30, and the control LSI 30 carries out switching control of the display mode.

The image display apparatus 1 is arranged so as to carry out time-division driving to carry out pseudo impulse display which suppresses the unfocused moving image. That is, the image display apparatus 1 is arranged so as to divide one frame into a plurality of sub-frames to drive the display panel 10. Specifically, the switching of the display mode in the image display apparatus 1 is carried out by switching a luminance distribution ratio for the sub-frames in the time-division driving.

That is, in the time-division driving, the display luminance is distributed to respective sub-frames so that time integral values of the display luminance of the respective sub-frames reproduce a tone luminance characteristic in one frame period based on the input image signal. By this distribution of the display luminance to the sub-frames, a high luminance sub-frame(s) and a low luminance sub-frame(s) are produced. Because of this, the time-division driving display becomes the pseudo impulse display and achieves the effect of suppressing the unfocused moving image. The degree of this effect changes depending on the luminance distribution ratio. That is, if the distribution ratio is set such that the difference of luminance between the sub-frames is large, the effect of suppressing the unfocused moving image is large, and if the distribution ratio is set such that the difference of luminance between the sub-frames is small, the effect of suppressing the unfocused moving image is small.

Although the effect of suppressing the unfocused moving image can be obtained by carrying out the time-division driving, another problem is that the flicker tends to occur. The flicker tends to occur more often when the distribution ratio is set such that the difference of luminance between the sub-frames is large, and the flicker tends to occur less often when the distribution ratio is set such that the difference of luminance between the sub-frames is small.

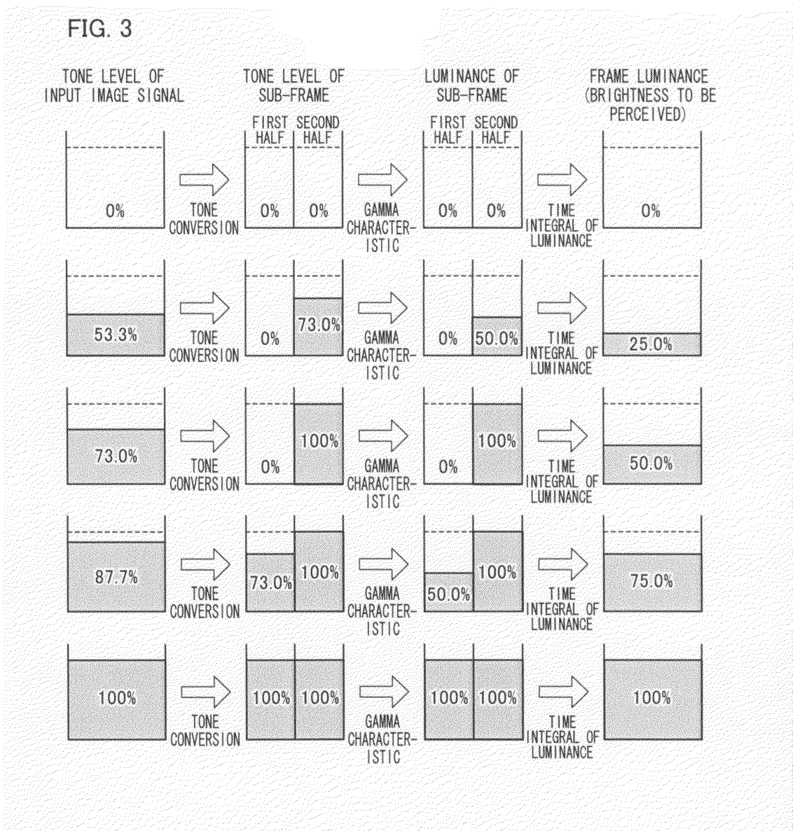

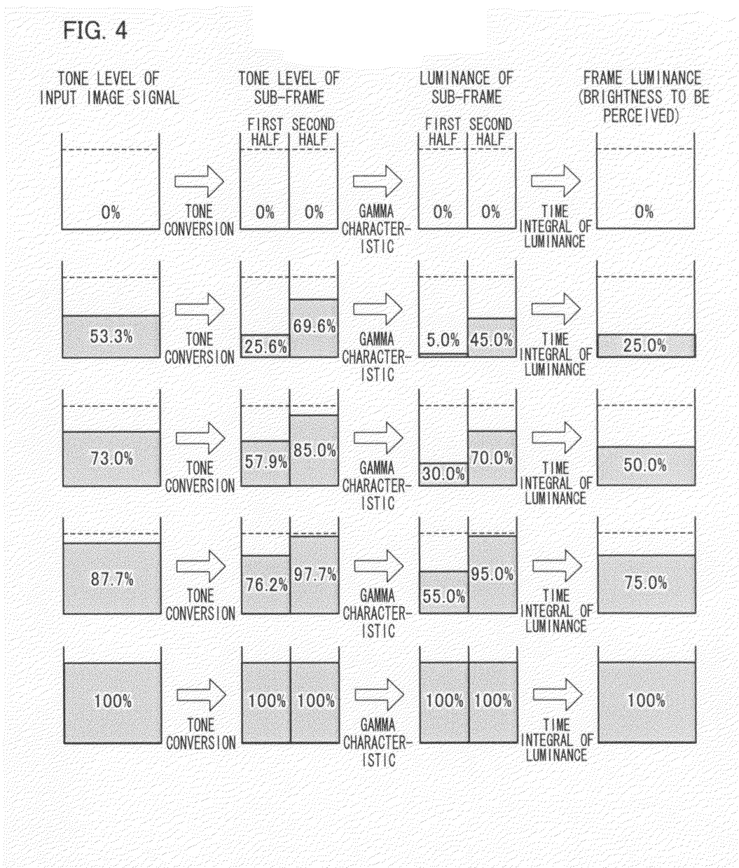

Therefore, the image display apparatus 1 has (i) a first display mode which gives priority to the effect of suppressing the unfocused moving image and (ii) a second display mode which reduces the effect of suppressing the unfocused moving image in light of the suppression of the flicker. In the first display mode, the distribution ratio is set such that the difference of luminance between the sub-frames is large, and in the second display mode, the distribution ratio is set such that the difference of luminance between the sub-frames is small. One example of the distribution ratio of the first display mode is shown in Table 1, and one example of the distribution ratio of the second display mode is shown in Table 2. In Tables 1 and 2, assume that the number of sub-frames is two (that is, a first-half sub-frame and a second-half sub-frame), and a time ratio between these sub-frames is 1:1. Moreover, the luminance distribution based on the distribution ratio in Table 1 is shown in FIG. 3, and the luminance distribution based on the distribution ratio in Table 2 is shown in FIG. 4.

TABLE 1
When giving priority to the display performance of the moving image

| | | | | | Difference of | Frame |
|---|---|---|---|---|---|---|
| Input image | | | | | luminance | luminance |
| signal tone | Sub-frame tone level | | Sub-frame luminance | | between | (Integral |
| level | First half | Second half | First half | Second half | sub-frames | luminance) |
| 0.0 | 0.0 | 0.0 | 0.0 | 0.0 | 0.0 | 0.0 |
| 53.3 | 0.0 | 73.0 | 0.0 | 50.0 | 50.0 | 25.0 |
| 73.0 | 0.0 | 100.0 | 0.0 | 100.0 | 100.0 | 50.0 |
| 87.7 | 73.0 | 100.0 | 50.0 | 100.0 | 49.9 | 75.0 |
| 100.0 | 100.0 | 100.0 | 100.0 | 100.0 | 0.0 | 100.0 |

* Unit (%)

TABLE 2
When suppressing the occurrence of the flicker

| | | | | | Difference of | Frame |
|---|---|---|---|---|---|---|
| Input image | | | | | luminance | luminance |
| signal tone | Sub-frame tone level | | Sub-frame luminance | | between | (Integral |
| level | First half | Second half | First half | Second half | sub-frames | luminance) |
| 0.0 | 0.0 | 0.0 | 0.0 | 0.0 | 0.0 | 0.0 |
| 53.3 | 25.6 | 69.6 | 5.0 | 45.0 | 40.0 | 25.0 |
| 73.0 | 57.9 | 85.0 | 30.0 | 70.0 | 40.0 | 50.0 |
| 87.7 | 76.2 | 97.7 | 55.0 | 95.0 | 40.0 | 75.0 |
| 100.0 | 100.0 | 100.0 | 100.0 | 100.0 | 0.0 | 100.0 |

* Unit (%)

FIG. 3 shows the first display mode which gives priority to the display performance of the moving image, and shows the luminance distribution for the sub-frames when the tone level of the input image signal is 0% (frame luminance: 0%), 53.3% (frame luminance: 25%), 73.0% (frame luminance: 50%), 87.7% (frame luminance: 75%) or 100% (frame luminance: 100%). Note that a relation between the frame luminance and the tone level of the input image signal satisfies Formula 1 below. Moreover, it is known that when γ (gamma characteristic) is 2.2 in Formula 1, a characteristic similar to actual display can be obtained.

$$\begin{matrix}( \begin{matrix}Frame \\ luminance\end{matrix} ) = {( Input image signal tone level )}^{γ} \\ = \frac{( \begin{matrix}{( First \text{-} half sub \text{-} frame tone level )}^{γ} \\ {( Second \text{-} half sub \text{-} frame tone level )}^{γ}\end{matrix} )}{2}\end{matrix} \qquad [ Formula 1 ]$$

In the first display mode shown in Table 1 and FIG. 3, when the frame luminance is in a range from 0% to 50%, the luminance of one sub-frame (the first-half sub-frame in the example) is fixed to minimum luminance (0%), and the luminance of another sub-frame (the second-half sub-frame in the example) is changed. Moreover, when the frame luminance is in a range from 50% to 100%, the luminance of one sub-frame (the second-half sub-frame in the example) is fixed to maximum luminance (100%), and the luminance of another sub-frame (the first-half sub-frame in the example) is changed. Thus, in the first display mode, the difference of luminance between the sub-frames becomes maximum at each tone level. Therefore, it is possible to carry out the time-division driving having the high effect of preventing the unfocused moving image.

FIG. 4 shows the second display mode which considers the suppression of the flicker while improving the display performance of the moving image, and shows the luminance distribution for the sub-frames when the tone level of the input image signal is 0% (frame luminance: 0%), 53.3% (frame luminance: 25%), 73.0% (frame luminance: 50%), 87.7% (frame luminance: 75%) or 100% (frame luminance: 100%).

In the second display mode shown in Table 2 and FIG. 4, there exists the difference of luminance between the first-half sub-frame and the second-half sub-frame. However, even in the case of displaying halftone, the luminance of the sub-frame is not fixed to the minimum luminance or the maximum luminance. Thus, in the second display mode, the difference of luminance between the sub-frames is smaller at each tone level than that in the first display mode, so that the effect of preventing the unfocused moving image in the second display mode is smaller than that in the first display mode, but it is possible to carry out the time-division driving which can suppress the occurrence of the flicker.

Next, referring to FIG. 1, the following will explain an arrangement of the control LSI 30 which carries out switching control of the first and second display modes.

As shown in FIG. 1, the control LSI 30 includes a line buffer 31, a timing controller 32, a frame memory data selector 33, a first tone converting circuit 34, a second tone converting circuit 35, an output data selector 36, a first LUT (Look Up Table) 37, a second LUT 38, a third LUT 39, a fourth LUT 40, a first selector 41 and a second selector 42.

The line buffer 31 receives and once holds the input image signals of one horizontal line. The line buffer 31 separately includes a reception port and a transmission port, and can simultaneously carry out reception and transmission of the input image signal.

The timing controller 32 controls the frame memory data selector 33 so as to alternately switch between a timing of data transfer to the frame memory 20 and a timing of data readout from the frame memory 20. Moreover, the timing controller 32 controls the output data selector 36 so as to alternately select a timing of an output from the first tone converting circuit 34 and a timing of an output from the second tone converting circuit 35. That is, the timing controller 32 controls the output data selector 36 so as to switch between the first-half sub-frame period and the second-half sub-frame period. Further, the timing controller 32 outputs, with predetermined timings, the clock signal, the latch pulse signal, the enable signal, the start pulse signal and the vertical shift clock signal which are generated based on an input synchronization signal.

The frame memory data selector 33 is controlled by the timing controller 32, and alternately selects (i) an operation of data transfer of the input image signals of one horizontal line to the frame memory 20, the input image signals being held in the line buffer 31, and (ii) an operation of readout of the image signals of one horizontal line, the image signals being supplied in the previous frame and stored in the frame memory 20. In addition, the frame memory data selector 33 transfers image data, read out from the frame memory 20, to the second tone converting circuit 35.

The first tone converting circuit 34 receives the input image signal from the line buffer 31, converts the tone level of the input image signal into the tone level of the first-half sub-frame for carrying out the time-division driving, and outputs the signal. When the first tone converting circuit 34 converts the tone level, it refers to the first LUT 37 or the second LUT 38.

The second tone converting circuit 35 receives the input image signal from the frame memory 20 via the frame memory data selector 33, converts the tone level of the input image signal into the tone level of the second-half sub-frame for carrying out the time-division driving, and outputs the signal. When the second tone converting circuit 35 converts the tone level, it refers to the third LUT 39 or the fourth LUT 40.

Moreover, in the first tone converting circuit 34 and the second tone converting circuit 35, the tone level of the sub-frame to be output is changed in accordance with the switching of the display modes. Therefore, the first tone converting circuit 34 is connected to the first LUT 37 and the second LUT 38 via the first selector 41, and the second tone converting circuit 35 is connected to the third LUT 39 and the fourth LUT 40 via the second selector 42.

In the arrangement shown in FIG. 1, there are two distributing means, the first LUT 37, the second LUT 38 and the first selector constitute a first distributing means, and the third LUT 39, the fourth LUT 40 and the second selector 42 constitute a second distributing means.

That is, the mode switching signal is supplied to the first selector 41, and the first selector 41 switches between the first LUT 37 and the second LUT 38 in accordance with the mode switching signal so as to determine the LUT referred by the first tone converting circuit 34. Similarly, the mode switching signal is supplied to the second selector 42, and the second selector 42 switches between the third LUT 39 and the fourth LUT 40 in accordance with the mode switching signal so as to determine the LUT referred by the second tone converting circuit 35.

Assume that when the mode switching signal indicating the first display mode is supplied, the first tone converting circuit 34 refers to the first LUT 37, and the second tone converting circuit 35 refers to the third LUT 39. In this case, the tone level of the first-half sub-frame at the time of the first display mode is associated with the tone level of the input image signal and stored in the first LUT 37. Moreover, the tone level of the second-half sub-frame at the time of the first display mode is associated with the tone level of the input image signal and stored in the third LUT 39.

Similarly, assume that when the mode switching signal indicating the second display mode is supplied, the first tone converting circuit 34 refers to the second LUT 38, and the second tone converting circuit 35 refers to the fourth LUT 40. In this case, the tone level of the first-half sub-frame at the time of the second display mode is associated with the tone level of the input image signal and stored in the second LUT 38. Moreover, the tone level of the second-half sub-frame at the time of the second display mode is associated with the tone level of the input image signal and stored in the fourth LUT 40.

The output data selector 36 is controlled by the timing controller 32, and switches between the image signal output from the first tone converting circuit 34 and the image signal output from the second tone converting circuit 35, so as to output the panel image signal. That is, in the first-half sub-frame period, the output data selector 36 outputs, as the panel image signal, the image signal output from the first tone converting circuit 34, and in the second-half sub-frame period, the output data selector 36 outputs, as the panel image signal, the image signal output from the second tone converting circuit 35.

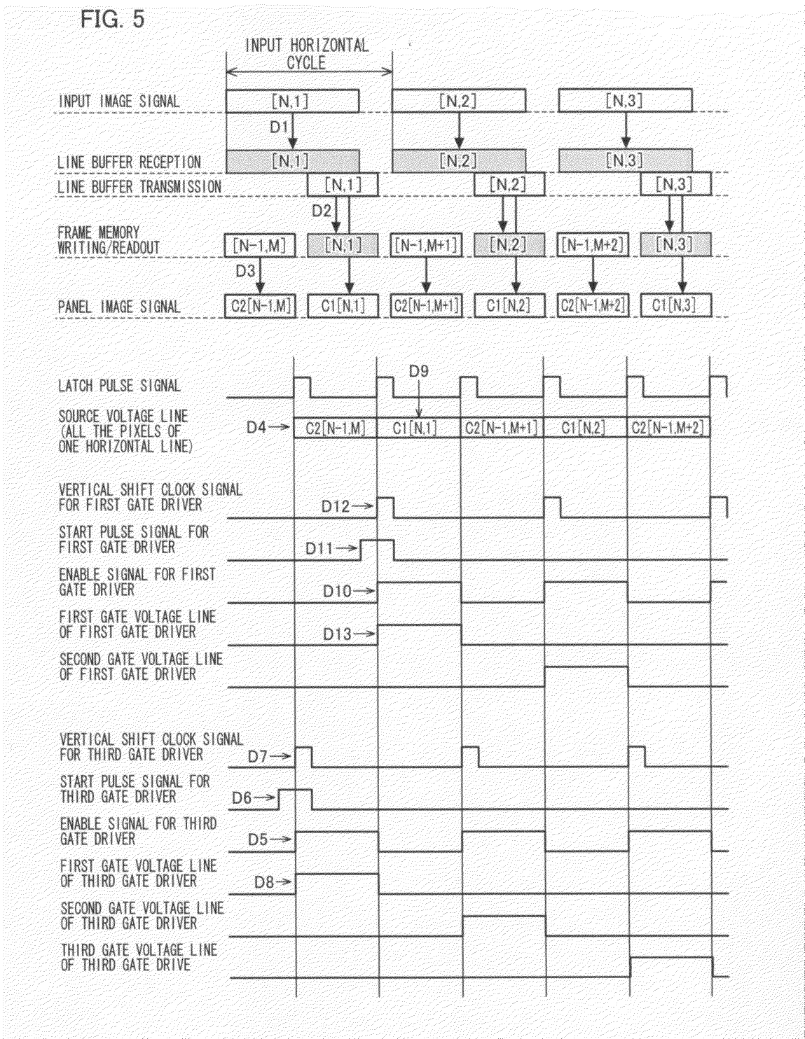

Referring to FIG. 5, the following will explain an operation of the image display apparatus 1 which uses the control LSI 30 arranged as above. FIG. 5 is a diagram showing a flow of the image signal of each horizontal period in the image display apparatus of the present embodiment 1. FIG. 5 shows a period in which the input image signals of the first to third lines in an N-th frame are supplied. Moreover, the operation explained below is basically the same between at the time of the first display mode and at the time of the second display mode.

In parentheses [ ] in FIG. 5, a transfer period of the image signals of one horizontal line is shown. For example, [N, 1] indicates that the input image signal supplied to a horizontal first line of the N-th frame has been transferred. Moreover, an M-th line indicates an intermediate line of a screen, and in the present embodiment 1, the M-th line is a horizontal line driven by a first gate voltage line of the third gate driver 14c.

Moreover, C1 indicates that transferred is the image signal converted in the first tone converting circuit 34 using, as a source, the input image signal of the frame and the horizontal line shown in [ ] shown after C1. Further, C2 indicates that transferred is the image signal converted in the second tone converting circuit 35 using, as a source, the input image signal of the frame and the horizontal line shown in [ ] shown after C2.

First, as shown by an arrow D1 in FIG. 5, the input image signal is received by the line buffer 31. Next, as shown by an arrow D2, from the midst of the reception of the image signals of one line, the line buffer 31 starts carrying out writing to the frame memory 20 via the frame memory data selector 33 and carrying out transfer to the first tone converting circuit 34. The first tone converting circuit 34 outputs the converted image signal as the panel image signal.

Moreover, as shown by an arrow D3, alternately with the writing to the frame memory 20, the image signals of one line is read out from the frame memory 20, the image signals being image signals of the horizontal line which is past by a half frame from the line of the image signals to be written. The image signal read out from the frame memory 20 is transferred to the second tone converting circuit 35 via the frame memory data selector 33, and the second tone converting circuit 35 outputs the converted image signal as the panel image signal.

Further, when the latch pulse signals are supplied to the first to fourth source drivers after the panel image signals of one horizontal line output from the control LSI 30 are transferred to the first to fourth source drivers by the clock signal, each source voltage line outputs the display voltage in accordance with the display luminance of each pixel portion. At this time, the vertical shift clock signal and the gate start pulse signal are supplied, according to need, to the gate driver relevant to a line to which the electric charge (display voltage) on the source voltage line is supplied so as to carry out image display, so that a scanning signal of the relevant gate voltage line becomes an ON state. Meanwhile, regarding the gate driver which does not carry out image display, the enable signal is the low level, and the scanning signal of the gate voltage line is in an OFF state.

In the example shown in FIG. 5, after the image signals of one horizontal line of the M-th line of the N−1-th frame are transferred to the source driver as shown by an arrow D4, the enable signal supplied from the control LSI 30 to the third gate driver 14c is the high level as shown by an arrow D5, and the control LSI 30 supplies the start pulse signal and the vertical shift clock signal to the third gate driver 14c as shown by arrows D6 and D7. With this, as shown by an arrow D8, the TFT 12b connected to the first gate voltage line of the third gate driver 14c becomes an ON state (the first gate voltage line of the third gate driver 14c corresponds in display position to the M-th line of the screen), and the image display is carried out. At this time, the enable signals to the first, second and fourth gate drivers 14a, 14b and 14c which are not relevant to the display position are the low level, and the TFTs 12b connected to the gate voltage lines of these gate drivers are in an OFF state.

Next, after the image signals of one horizontal line of the first line of the N-th frame are transferred to the source driver as shown by an arrow D9, the enable signal from the control LSI 30 to the first gate driver 14a is the high level as shown by an arrow D10, and the control LSI 30 supplies the start pulse signal and the vertical shift clock signal to the first gate driver 14a as shown by arrows D11 and D12. With this, as shown by an arrow D13, the TFT 12b connected to the first gate voltage line of the first gate driver 14a becomes an ON state (the first gate voltage line of the first gate driver 14a corresponds in display position to the first line of the screen, and the image display is carried out. At this time, the enable signals to the second to fourth gate drivers 14b to 14c which are not relevant to the display position are the low level, and the TFTs 12b connected to the gate voltage lines of these gate drivers are in an OFF state.

Note that the above explained operation based on FIG. 5 is just one example for carrying out the time-division driving in the image display apparatus 1, and the present invention is not limited to this.

For example, in the above explanation, the number of sub-frames is two. However, this number is not limited to this, and the frame may be divided into three or more sub-frames. Moreover, a split ratio for the sub-frames does not have to be an equal division (1:1, etc.), and the frame division can be carried out with an arbitrary split ratio (for example, 2:1 or 3:2). The same is true for Embodiments 2 to 6 below.

Moreover, in the above explanation, in the second display mode which reduces the effect of suppressing the unfocused moving image in light of the suppression of the flicker, the distribution ratio is set such that the difference of luminance between the sub-frames is smaller than that in the first display mode. Here, the second display mode includes such a display mode that the difference of luminance between the sub-frames is 0. The difference of luminance between the sub-frames being means that the display of constant luminance is carried out in the entire frame period, so that this display mode is the same as a conventional hold display. Therefore, the effect of suppressing the unfocused moving image cannot be obtained. However, even when the difference of luminance between the sub-frames is 0 in the second display mode, its driving mode is such a driving mode that one frame is divided into a plurality of sub-frames, as with the first display mode. Therefore, this is regarded as the time-division driving. Again, the same is true for Embodiments 2 to 6 below.

Further, in the second display mode, it is unnecessary that the distribution ratio be set such that at every tone level of the input image signal, the difference of luminance between the sub-frames is smaller than that in the first display mode. For example, it is also possible that in such a range that the tone level of the input image signal is comparatively low luminance or comparatively high luminance, the luminance distribution ratio for the sub-frames in the first display mode is the same as that in the second display mode, and the luminance distribution ratio for the sub-frames in the first display mode is different from that in the second display mode only in such a range that the tone level of the input image signal is intermediate luminance. Again, the same is true for Embodiments 2 to 6 below.

Moreover, in the image display apparatus 1 in the above explanation, each of the first tone converting circuit 34 and the second tone converting circuit 35 carries out the conversion of the tone level by reading out, from the LUT (first to fourth LUTs 37 to 40), the tone level of each sub-frame corresponding to the tone level of the input image signal. Then, to carry out the switching control between the first and second display modes, the switching of the first to fourth LUTs 37 to 40 is carried out.

However, the present invention is not limited to this, and each of the first tone converting circuit 34 and the second tone converting circuit 35 may calculate, using a formula, the tone level of each sub-frame corresponding to the tone level of the input image signal. In this case, to carry out the switching control between the first and second display modes, (coefficients of) the formula may be changed in accordance with the mode switching signal.

Note that in the image display apparatus 1 of the present embodiment 1, the switching of the display modes is carried out by the user's instruction input from the mode selector switch 50. However, the image display apparatus of the present invention may be arranged such that the apparatus itself determines the content of the display image, and an appropriate display mode is automatically selected in accordance with the result of the determination. The image display apparatus thus arranged is explained in Embodiments 2 to 4 below.

### Embodiment 2

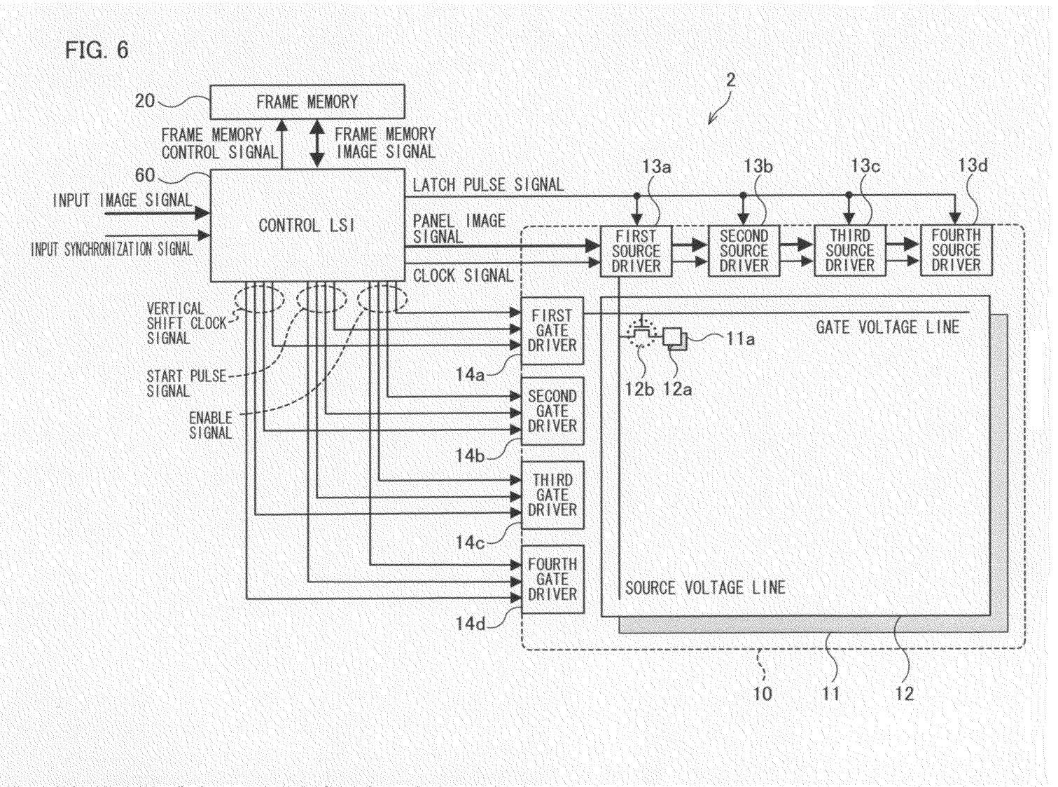

The image display apparatus of the present embodiment 2 is shown in FIG. 6. The image display apparatus 2 shown in FIG. 6 is different from the image display apparatus 1 shown in FIG. 2 in that the mode selector switch 50 is not included, and a control LSI 60 is included instead of the control LSI 30. The other members in the image display apparatus 2 are the same as those in the image display apparatus 1, so that the same reference numerals are used for the members having the same functions as the members, shown in FIG. 2, in the image display apparatus 1, and detailed explanations thereof are omitted here.

In the image display apparatus 2, the control LSI 60 determines based on the input image signal whether the display image is the moving image or the still image, and the control LSI 60 selects an appropriate display mode in accordance with the result of the determination. That is, since the time-division driving of the image display apparatus of the present invention has the effect of suppressing the unfocused moving image, this effect does not work (or this effect is small) when the image display apparatus displays the still image (or a moving image which is like a still image since it includes less movement). Therefore, it is preferable that (i) when the display image is the moving image, the display be carried out by the first display mode which gives priority to the unfocused moving image, and (ii) when the display image is the still image, the display be carried out by the second display mode which reduces the effect of suppressing the unfocused moving image in light of the suppression of the flicker.

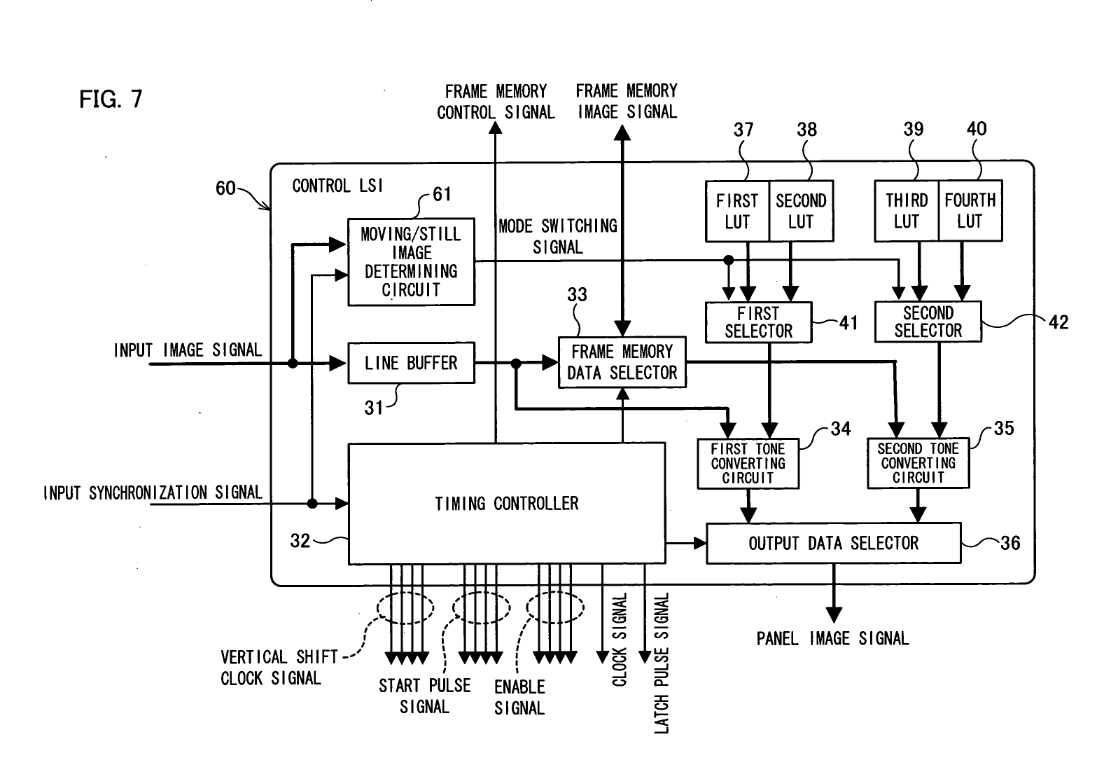

Referring to FIG. 7, the following will explain an arrangement of the control LSI 60 which carries out the above switching operation of the display modes. The control LSI 60 is obtained by further adding a moving/still image determining circuit 61 to the control LSI 30 shown in FIG. 1. The same reference numerals are used for the members having the same functions as the members, shown in FIG. 1, in the control LSI 30, and detailed explanations thereof are omitted here.

The moving/still image determining circuit 61 receives the input image signal and the input synchronization signal, determines whether the display image is the moving image or the still image on the basis of these signals, and outputs the mode switching signal on the basis of the result of the determination. The mode switching signal output from the moving/still image determining circuit 61 is supplied to the first selector 41 and the second selector 42. That is, in the image display apparatus 2 shown in FIG. 6, the mode switching signal is not generated by the input from the user, but it is generated by the moving/still image determining circuit 61 on the basis of the content of the display image.

As a moving/still image determining method of the moving/still image determining circuit 61, it is possible to use, for example, (i) a method for comparing data of corresponding pixels between consecutive plural frames and checking whether or not there are changes between these frames or (ii) a method for extracting a movement vector(s) in the display image from consecutive plural frames and determining whether the display image is the moving image or the still image in accordance with the size of the vector. Note that the moving/still image determining method is a technique which has already been used for, for example, a processing carried out when carrying out image compression, and any publicly known method can be used as the moving/still image determining method. Therefore, in the present invention, a specific method for the moving/still image determination is not especially limited.

The moving/still image determining circuit 61 determines whether the display image is the moving image or the still image. The still image herein means not only a complete still image which includes no movement but also an image which includes comparatively less movement than the moving image herein.

For example, the moving/still image determining circuit 61 compares data of corresponding pixels between consecutive frames, counts the number of pixels which are different between the frames, and compares the number of such pixels with a predetermined threshold value. In this way, it is possible to determine whether it is an image including much movements (regarded as the moving image) or an image including less movements (regarded as the still image).

### Embodiment 3

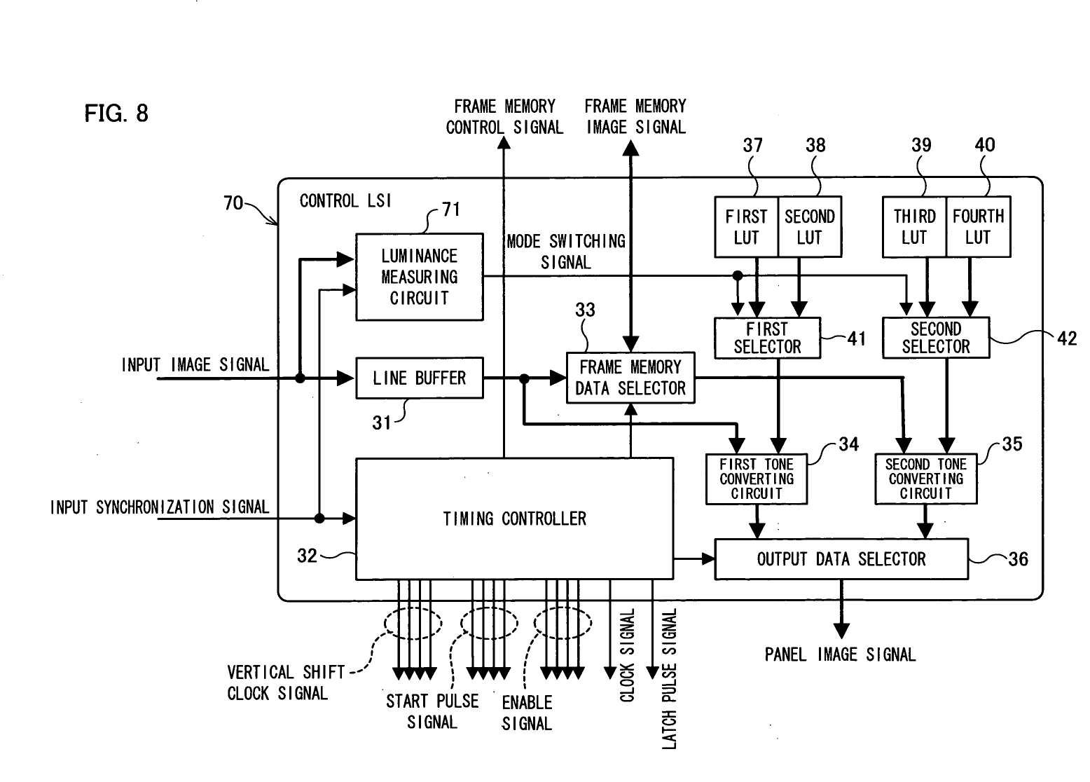

An image display apparatus of the present embodiment 3 is substantially the same as the image display apparatus 2 shown in FIG. 6 except that a control LSI 70 shown in FIG. 8 is included instead of the control LSI 60. The control LSI 70 is obtained by replacing the moving/still image determining circuit 61 of the control LSI 60 shown in FIG. 7 with a luminance measuring circuit 71.

In the image display apparatus of the present embodiment 3, the control LSI 70 measures (calculates) average luminance of the input image signal, and selects an appropriate display mode in accordance with the result of the measurement (calculation). That is, in the time-division driving in the image display apparatus of the present invention, generally, the flicker tends to occur when the luminance of the display image is high, and the flicker hardly occurs when the luminance of the display image is low. Therefore, it is preferable that (i) when the luminance of the display image is low, the display be carried out by the first display mode which gives priority to the effect of suppressing the unfocused moving image, and (ii) when the luminance of the display image is high, the display be carried out by the second display mode which reduces the effect of suppressing the unfocused moving image in light of the suppression of the flicker.

As shown in FIG. 8, the luminance measuring circuit 71 receives the input image signal and the input synchronization signal, measures (calculates) the average luminance of the display image on the basis of these signals, and outputs the mode switching signal on the basis of the result of the measurement (calculation). The mode switching signal output from the luminance measuring circuit 71 is supplied to the first selector 41 and the second selector 42. Note that when calculating the above average luminance, tone value data in the input image signal is utilized practically.

As a luminance measuring method of the luminance measuring circuit 71, it is possible to use, for example, a method for calculating an average luminance data value (that is, the average luminance) of a plurality of pixels in a frame(s). Note that the average luminance may be calculated for a single frame or for consecutive plural frames. Moreover, the average luminance may be calculated by using all the pixels in the frame(s) or using part of the pixels in the frame(s). Note that the luminance measuring method is a technique which has already been used for, for example, a processing carried out when controlling the backlight of the liquid crystal display apparatus in accordance with the luminance of the display image, and any publicly known method can be used as the luminance measuring method. Therefore, in the present invention, a specific method for the luminance measurement is not especially limited.

### Embodiment 4

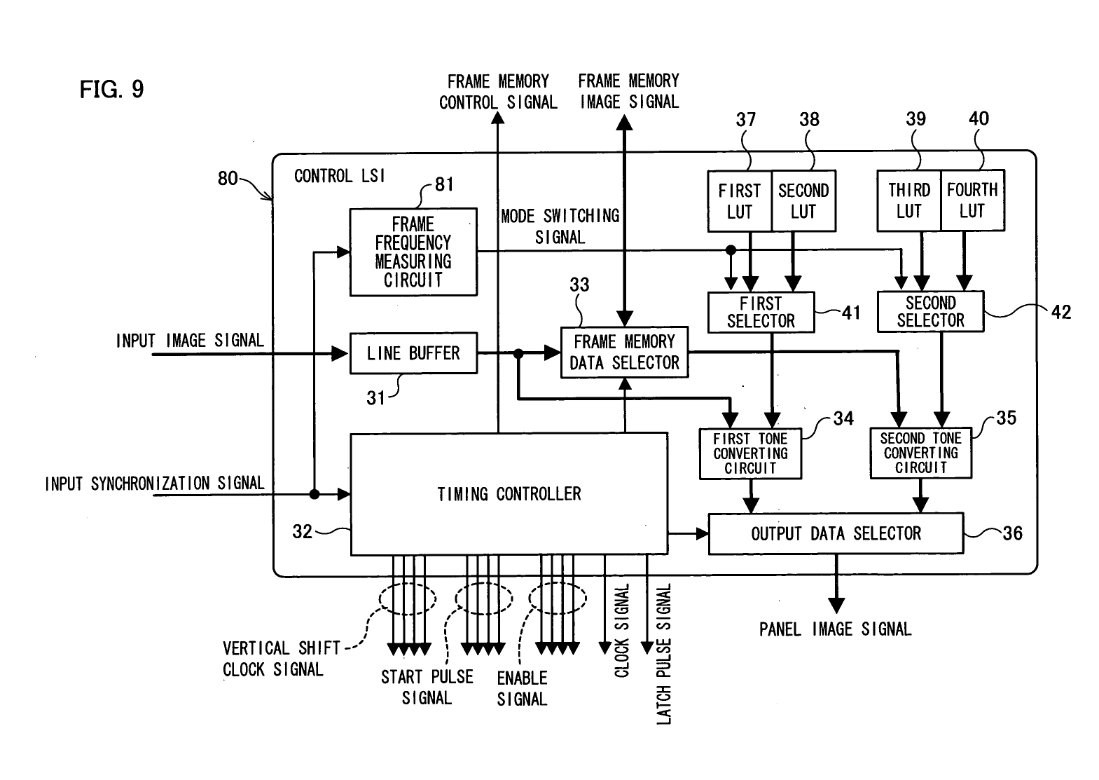

An image display apparatus of the present embodiment 4 is substantially the same as the image display apparatus 2 shown in FIG. 6 except that a control LSI 80 shown in FIG. 9 is included instead of the control LSI 60. The control LSI 80 is obtained by replacing the moving/still image determining circuit 61 of the control LSI 60 shown in FIG. 7 with a frame frequency measuring circuit 81.

In the image display apparatus of the present embodiment 4, the control LSI 80 measures a frame frequency of the input image signal, and selects an appropriate display mode in accordance with the result of the measurement. That is, in the time-division driving in the image display apparatus of the present invention, generally, the flicker hardly occurs when the frame frequency is high, and the flicker tends to occur when the frame frequency is low. Therefore, it is preferable that (i) when the luminance frame frequency of the display image is high, the display be carried out by the first display mode which gives priority to the effect of suppressing the unfocused moving image, and (ii) when the frame frequency of the display image is low, the display be carried out by the second display mode which reduces the effect of suppressing the unfocused moving image in light of the suppression of the flicker.

As a more specific example, it is preferable that (i) when it is determined that the frame frequency is about 60 Hz, the display be carried out by the first display mode, and (ii) when it is determined that the frame frequency is about 50 Hz, the display be carried out by the second display mode. In this case, a threshold value of the frame frequency which is a standard for switching the display mode may be set between 50 Hz and 60 Hz. Setting the threshold value of the frame frequency between 50 Hz and 60 Hz is preferable since a 50 Hz (PAL) signal and a 60 Hz (NTSC) signal are generally used as a signal of a television image.

As shown in FIG. 9, the frame frequency measuring circuit 81 receives the input synchronization signal, measures the frame frequency of the display image on the basis of the input synchronization signal, and outputs the mode switching signal on the basis of the result of the measurement. The mode switching signal output from the frame frequency measuring circuit 81 is supplied to the first selector 41 and the second selector 42.

As a frame frequency measuring method in the frame frequency measuring circuit 81, it is possible to use, for example, a method for extracting the frame frequency from the input synchronization signal by (i) providing, in the frame frequency measuring circuit 81, a synchronous counter which operates by a clock whose frequency is fixed to be constant (for example, an output of a crystal oscillator), and (ii) counting vertical cycles of the input synchronization signal. However, in the present invention, a specific method for the frame frequency measurement is not especially limited.

Note that any two or all of three members explained in Embodiments 2 to 4 may be combined in the image display apparatus of the present invention. Moreover, the mode selector switch 50 explained in Embodiment 1 may be further added to the above apparatus.

Further, the moving/still image determining processing in Embodiment 2, the luminance measuring processing in Embodiment 3 and the frame frequency measuring processing in Embodiment 4 may be continuously carried out during the input period of the image signal. However, to reduce burden of the moving/still image determining circuit 61, the luminance measuring circuit 71 or the frame frequency measuring circuit 81, the determination or measurement may be carried out intermittently (for example, the determination or measurement is carried out each time a certain period has passed.

### Embodiment 5

An image display apparatus of the present embodiment 5 is characterized by selecting an appropriate display mode in accordance with a supply source (image source) of an image to be displayed on the display panel 10. That is, many of recent image display apparatuses are arranged so that the image signal can be supplied from various image sources, such as personal computers, television tuners, videos and games. The characteristic (especially, a moving image characteristic) of the image signal to be supplied can be defined to some extent depending on the image source. For example, the image signal supplied from the personal computer normally carries an image whose moving image characteristic is low (an image which is like a still image since it includes less movement), as compared with the image signal supplied from the other image source.

Therefore, in the image display apparatus of the present embodiment 5, it is contemplated that (i) when the image source is determined, and for example, the image source is a source other than the personal computer, the display is carried out by the first display mode which gives priority to the effect of suppressing the unfocused moving image, and (ii) when the image source is the personal computer, the display is carried out by the second display mode which reduces the effect of suppressing the unfocused moving image in light of the suppression of the flicker.

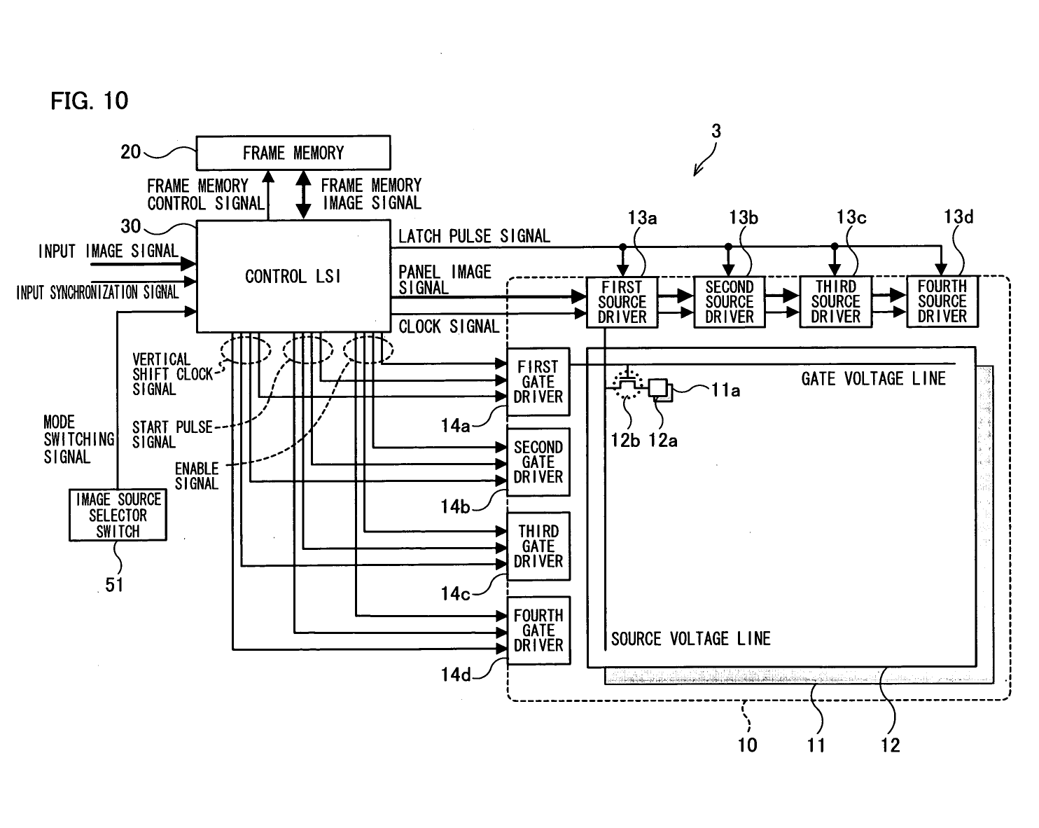

The image display apparatus which carries out the above control is shown in FIG. 10, for example. An image display apparatus 3 shown in FIG. 10 is different from the image display apparatus 1 shown in FIG. 2 in that an image source selector switch 51 is included instead of the mode selector switch 50. The other members in the image display apparatus 3 are the same as those in the image display apparatus 1, so that the same reference numerals are used for the members having the same functions as the members, shown in FIG. 2, in the image display apparatus 1, and detailed explanations thereof are omitted here.

The image display apparatus 3 carries out the switching of the image sources on the basis of the user's instruction input by the image source selector switch 51, and outputs the mode switching signal on the basis of the selected image source. This mode switching signal is supplied to the control LSI 30, and the following operations are the same as those in the image display apparatus 1 explained in Embodiment 1. Note that the switching control of the image sources is commonly carried out in an image display apparatus which can display the image signals supplied from a plurality of image sources, so that detailed explanations thereof are omitted here.

Moreover, the member explained in the present embodiment 5 can be used by arbitrarily combining with the members explained in Embodiments 1 to 4.

### Embodiment 6

As with the image display apparatuses of Embodiments 2 and 3, an image display apparatus of the present embodiment 6 is arranged such that the apparatus itself determines the content of the display image, and an appropriate display mode is automatically selected in accordance with the result of the determination. In the image display apparatuses of Embodiments 2 and 3, the switching of the display mode is carried out for the entire frame image. However, the image display apparatus of the present embodiment 6 is characterized in that the determination is carried out for respective pixels of the frame image, and the switching of the display modes is carried out for respective determined pixels.

For example, the image display apparatus of the present embodiment 6 can carry out such a display control that (i) pixels which display the moving image and pixels which display the still image are determined in the input image, (ii) in the pixels which display the moving image, the display is carried out by the first display mode which gives priority to the effect of suppressing the unfocused moving image, and (iii) in the pixels which display the still image, the display is carried out by the second display mode which reduces the effect of suppressing the unfocused moving image in light of the suppression of the flicker.

Basically, an image display apparatus which carries out the above display control can be realized by the same arrangement as the image display apparatus of Embodiment 2. That is, in Embodiment 2, the moving/still image determining circuit 61 of the control LSI 60 determines whether the image of the entire frame is the moving image or the still image. However, in the present embodiment 6, the moving/still image determining circuit 61 determines whether the image of each pixel is the moving image or the still image, and outputs the mode switching signal while switching the mode switching signal for each pixel which is determined as the pixel of the moving image or the pixel of the still image.

Moreover, it may be possible that in an image display apparatus having the same arrangement as the image display apparatus of Embodiment 3, the luminance measuring circuit 71 measures the luminance of each pixel and outputs the mode switching signal while switching the mode switching signal for each pixel whose luminance has been measured. In this case, it is possible to carry out such a display control that (i) pixels of low luminance in the display image and pixels of high luminance in the display image are determined in the input image, (ii) in the low luminance pixels, the display is carried out by the first display mode which gives priority to the effect of suppressing the unfocused moving image, and (iii) in the high luminance pixels, the display is carried out by the second display mode which reduces the effect of suppressing the unfocused moving image in light of the suppression of the flicker.

### Embodiment 7

As with the image display apparatuses of Embodiments 2 and 3, an image display apparatus of the present embodiment 7 is arranged such that the apparatus itself determines the content of the display image, and an appropriate display mode is automatically selected in accordance with the result of the determination. In the image display apparatuses of Embodiments 2 and 3, the switching of the display mode is carried out for the entire frame image. However, the image display apparatus of the present embodiment 7 is characterized in that areas are determined in the frame image, and the switching of the display modes is carried out for respective determined areas.

For example, the image display apparatus of the present embodiment 7 can carry out such a display control that (i) areas (moving image areas) where the moving image is displayed and areas (still image areas) where the still image is displayed are determined in the input image, (ii) in the moving image areas, the display is carried out by the first display mode which gives priority to the effect of suppressing the unfocused moving image, and (iii) in the still image areas, the display is carried out by the second display mode in light of the suppression of the flicker.

Alternatively, the image display apparatus of the present embodiment 7 can also carry out such a display control that (i) areas (low luminance areas) where the luminance of the display image is low and areas (high luminance area) where the luminance of the display image is high are determined in the input image, (ii) in the low luminance areas, the display is carried out by the first display mode which gives priority to the effect of suppressing the unfocused moving image, and (iii) in the high luminance areas, the display is carried out by the second display mode in light of the suppression of the flicker.

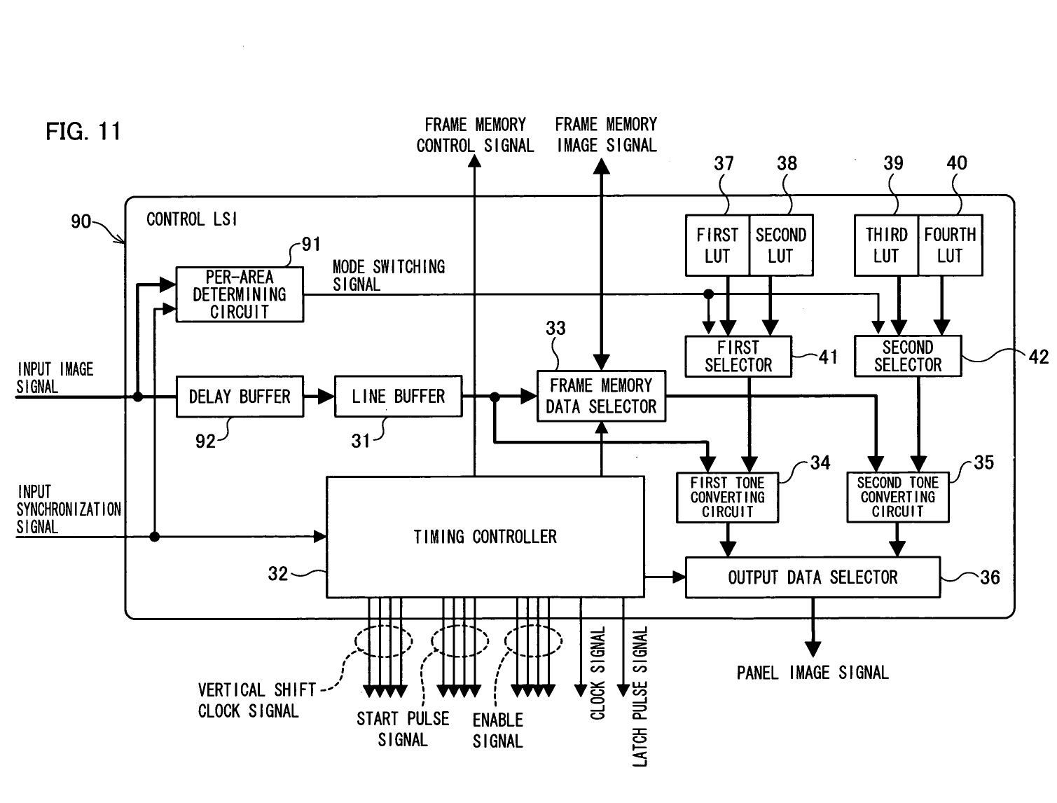

The image display apparatus of the present embodiment 7 is substantially the same as the image display apparatus 2 shown in FIG. 6 except that a control LSI 90 shown in FIG. 11 is included instead of the control LSI 60. The control LSI 90 is obtained by further adding a per-area determining circuit 91 and a delay buffer 92 to the control LSI 30 shown in FIG. 1.

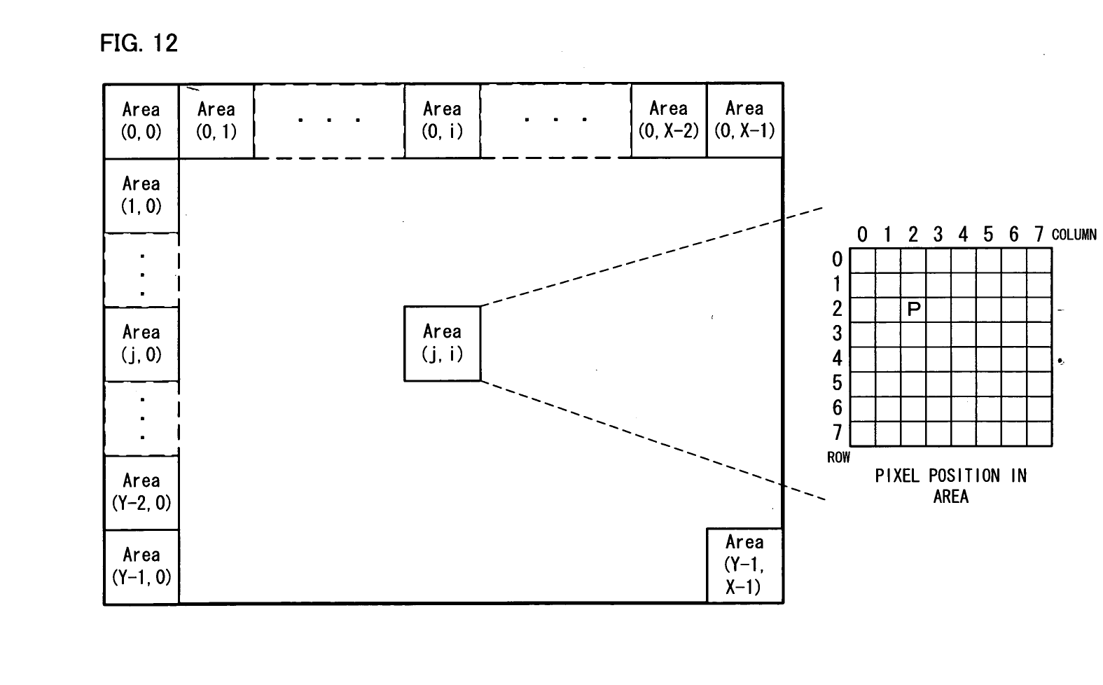

The per-area determining circuit 91 receives the input image signal and the input synchronization signal, determines the content of the input image signal for each predetermined block area on the basis of these input signals, and outputs the mode switching signal on the basis of the result of the determination. For example, as shown in FIG. 12, the per-area determining circuit 91 divides a display screen image into a plurality of block areas, and carries out, for each block area, the determination of the content of the input image and the switching of the mode switching signal. FIG. 12 shows an example in which the display screen image is divided into block areas (Y rows and X columns) each having 8×8 pixels.

Moreover, the per-area determining circuit 91 obtains the result of the determination of the content of the block area after collecting information of all the pixels in this block area. Therefore, a delay time is produced before outputting the mode switching signal. The delay buffer 92 is introduced prior to the line buffer 31 to synchronize, in light of the delay time, timings of (i) the mode switching signal output from the per-area determining circuit 91 and (ii) a picture signal output as the panel image signal.

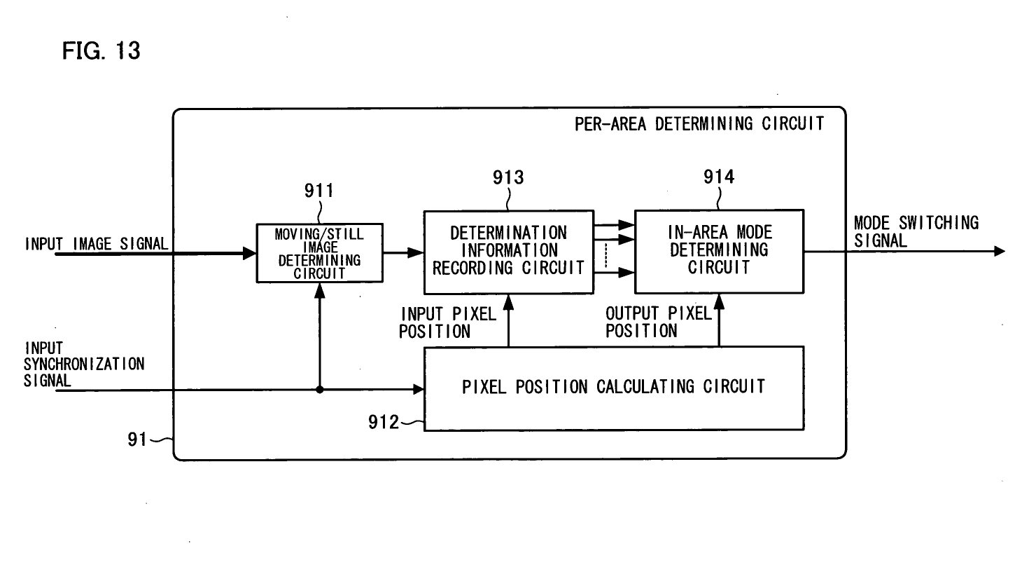

The following will explain one example of an arrangement of the per-area determining circuit 91 in reference to FIG. 13. FIG. 13 exemplifies an arrangement of the per-area determining circuit 91 which determines areas (moving image areas) where the moving image is displayed and areas (still image areas) where the still image is displayed in the input image.

The per-area determining circuit 91 includes a moving/still image determining circuit 911, a pixel position calculating circuit 912, a determination information recording circuit 913 and an in-area mode determining circuit 914.

The moving/still image determining circuit 911 basically has the same function as the moving/still image determining circuit 61 explained in Embodiment 2, and can determine whether the image of each pixel is the moving image or the still image on the basis of the input image signal. For example, the moving/still image determining circuit 911 outputs, to the determination information recording circuit 913, “1” when it is determined that the image is the moving image and “0” when it is determined that the image is the still image.

The pixel position calculating circuit 912 calculates a screen position of an input pixel and a screen position of an output pixel on the basis of the input synchronization signal.

The determination information recording circuit 913 records the result of the determination of the moving/still image determining circuit 911 on the basis of the screen position of the input pixel supplied from the pixel position calculating circuit 912. That is, the determination information recording circuit 913 sequentially records the result (1 or 0) of the determination of the moving/still image determining circuit 911 by using, as an address, the input pixel position (a position, on the screen, of a pixel which is input currently) output from the pixel position calculating circuit 912. For example, if the position of the pixel which is input currently is 50 (vertical) and 100 (horizontal) in a display resolution of 480 (vertical) times 640 (horizontal) pixels, one bit (1 or 0) of the result of the determination of the moving/still images is recorded using the address (50, 100).

On the basis of the screen position of the output pixel supplied from the pixel position calculating circuit 912, the in-area mode determining circuit 914 (i) reads out, from the determination information recording circuit 913, the result of the determination in the block area to which the output pixel belongs, (ii) carry out calculations using the result, (iii) determines the mode in the block area, and (iv) outputs the mode switching signal.

When the output pixel position (a position, on the screen, of a pixel which is about to output the mode switching signal) is supplied from the pixel position calculating circuit 913, the in-area mode determining circuit 914 carry out calculation to find out in which divided block area this pixel is included. Take a pixel P shown in FIG. 12 as an example. The calculation finds out that the pixel P is included in the block area Area (j, i). A formula for this calculation depends on the size of the block area. That is, when the display screen image is divided into areas each having M times N pixels (M and N are integers), and a y-coordinate (ordinate) of the pixel P on the screen is Py and an x-coordinate (abscissa) of the pixel P on the screen is Px, the block area Area (j, i) including the pixel P is obtained by the following formulas.

j=int(Py÷M)

i=int(Px÷N)

In the above formulas, into is a function which omits decimals of a numerical value in ( ) to convert the numerical value into an integer.

For example, when the display screen image is divided into block areas each having 8 times 8 pixels, and the output pixel position is a position of 50 (vertical, Py) and 100 (horizontal, Px), i and j are as follows.

i=int(50÷8)=int(6.25)=6

j=int(100÷8)=int(12.5)=12

### Thus, the calculation finds out that the pixel P is included in the block area Area (6, 12) in FIG. 12.

Next, the in-area mode determining circuit 914 simultaneously reads out, from the determination information recording circuit 913, the results of the determinations regarding all the pixels in the block calculated from the output pixel position, and determines which is larger, the number of pixels of the moving image or the number of pixels of the still image (that is, determines which is larger, the number of 1s or the number of 0s).

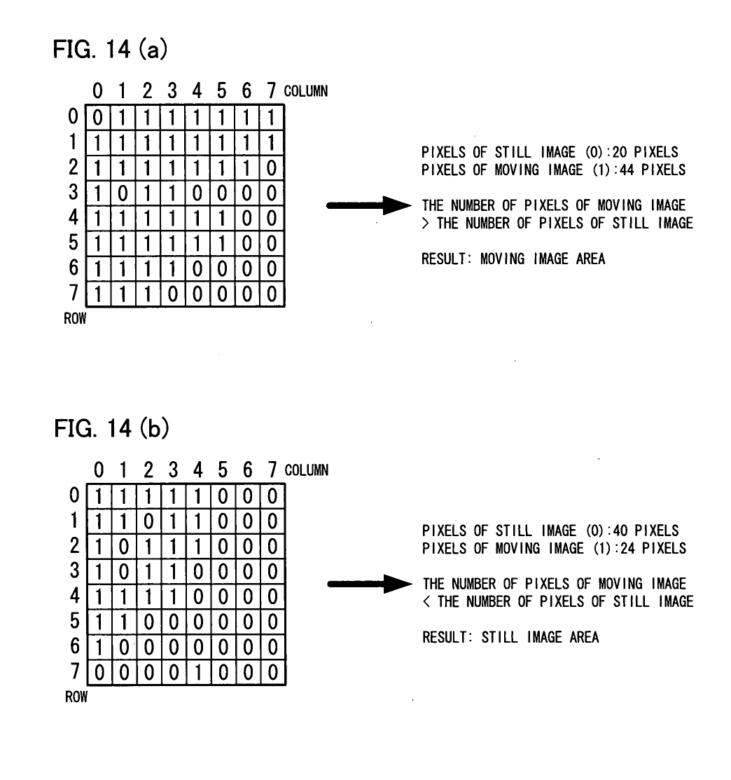

For example, FIG. 14(a) shows a result in which in the block area having 8 times 8 pixels, the number of pixels of the still image (0) is 20, and the number of pixels of the moving image (1) is 44. In this case, since the number of pixels of the moving image (1) is larger in this block area, the in-area mode determining circuit 914 determines that this block area is the moving image area, and outputs the mode switching signal to carry out display of the first display mode for improving the performance of the moving image.

Moreover, in an example shown in FIG. 14(b), since the number of pixels of the still image is larger, the in-area mode determining circuit 914 determines that this block area is the still image area, and outputs the mode switching signal to carry out display of the second display mode for suppressing the flicker.

Moreover, the method for determining the content of the block area is not limited to the above method for determining it based on which is larger, the number of pixels of the moving image or the number of pixels of the still image. There may be the other method which can simplify circuits or reduce capacity for recording the result of the determination.

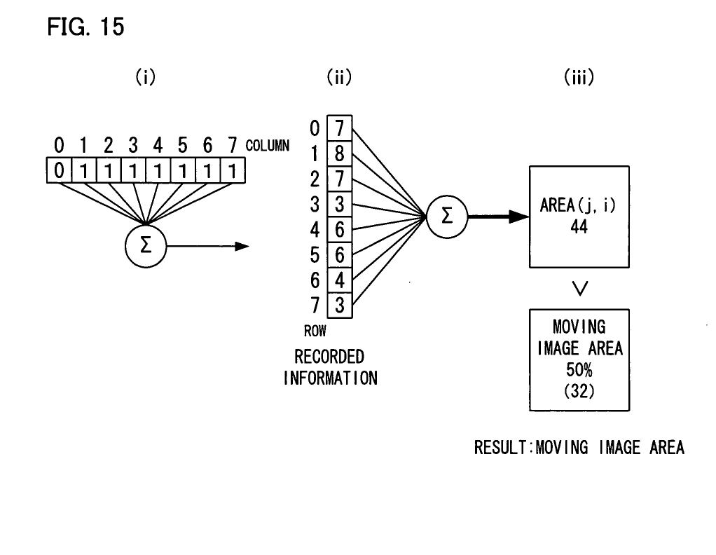

The following will explain the other example of the method for determining the content of the block area in reference to FIG. 15.

In Procedure (i) shown in FIG. 15, the determination information recording circuit 913 carries out an addition of the results (1 or 0) of the determinations regarding the pixels of the moving image or the pixels of the still image for each line of the block area. In Procedure (ii), the additional values are recorded for respective lines. In FIG. 15, the additional values of the number of pixels of the moving image in the example shown in FIG. 14(a) are recorded. Thus, regarding information recorded in the determination information recording circuit 913, the above method (method for determining the content of the block area based on which is larger, the number of pixels of the moving image or the number of pixels of the still image) requires 64 bits since one line of one block area is 8 bits and one column of one block area is 8 bits (8 bits times 8 bits). However, by the above addition of the results of the determinations for each line of the block, one line of one block requires only 4 bits, so that the information recorded for one block area is only 32 bits that is half the above method.

Moreover, when the in-area mode determining circuit 914 reads out the recorded information from the determination information recording circuit 913, it is not necessary to count the number of 1s or the number of 0s in the block, but as shown in Procedures (ii) and (iii), it is possible to obtain the number of pixels of the moving image in the block area by reading out 4-bit data of eight lines and adding them. By comparing the obtained number of pixels of the moving image in the block area with 32 that is 50% of the total number of pixels in the block area, it is possible to determine whether this block area is the moving image area or the still image area.

The method for switching signal generating means of the panel image signal on the basis of the mode switching signal is similar to that in the above embodiments, so that detailed explanations thereof are omitted here.

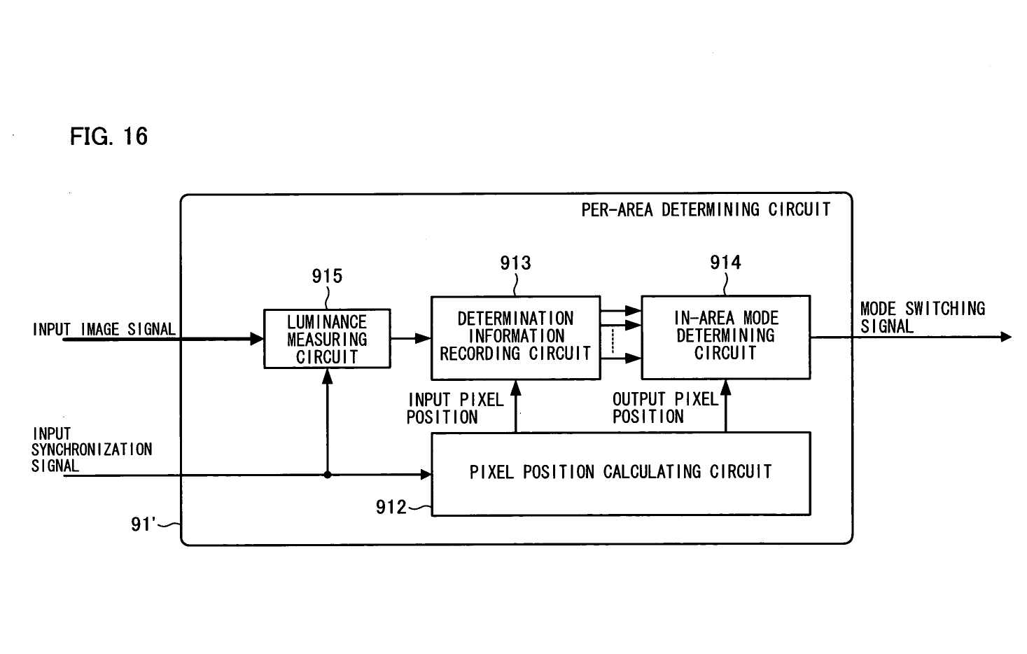

Moreover, if the per-area determining circuit 91 of the control LSI 90 shown in FIG. 11 is replaced with a per-area determining circuit 91′ shown in FIG. 16, it is possible to determine, in the input image, areas (low luminance areas) where the luminance of the display image is low and areas (high luminance areas) where the luminance of the display image is high, and carry out display control on the basis of the result of the determination.

The per-area determining circuit 91′ includes a luminance measuring circuit 915 instead of the moving/still image determining circuit 911. Except for this, the per-area determining circuit 91′ has the same arrangement as the per-area determining circuit 91 shown in FIG. 13. The luminance measuring circuit 915 basically has the same function as the luminance measuring circuit 71 explained in Embodiment 3, and can determine whether the luminance of each pixel is high luminance or low luminance on the basis of the input image signal. For example, the moving/still image determining circuit 911 outputs, to the determination information recording circuit 913, 1 when it is determined that the luminance of the pixel is the high luminance and when it is determined that the luminance of the pixel is the low luminance. The following operations may be the same as those of the per-area determining circuit 91, so that detailed explanations thereof are omitted here.

In the above explanation, the display image is divided into the block areas each having 8 times 8 pixels, however the size of the block area is not limited to the size of the 8 time 8 pixels. The display image may be divided into areas each having N times M pixels (N and M are integers).

Moreover, the shape of the divided area of the display image is not limited to the rectangular block in the above example, but may be any shape. Further, the divided areas of the display image do not have to be the same size as each other, and the sizes of the divided areas may be changed depending on the input image signal. For example, the size of the divided area is reduced when this divided area shows a minute picture portion of the input image, and the size of the divided area is increased when this divided area shows a smooth picture portion of the input image. In this way, it is possible to carry out a processing which matches the picture.

Moreover, in the above example, the mode of the divided area is determined by majority of the number of pixels in the area. A standard of the determination is not limited to 50%, but may be smaller (for example, 30%) or may be larger (for example, 70%). If this determination standard is changeable by an external operation, it is possible to adjust the quality of the moving image in accordance with user's preferences.

As above, in the image display apparatus of Embodiments 1 to 7, the display performance is controlled by the switching of the display modes (that is, by the change of the luminance distribution ratio for the sub-frames). The above explanation describes, as specific examples, that the display performance, such as the display characteristic of the moving image of the image display apparatus and the degree of occurrence of the flicker, is controlled by the switching of the display modes.

However, in the image display apparatus of the present invention, the display performance which can be controlled by the switching of the display modes is not limited to the above display characteristic of the moving image or the above degree of occurrence of the flicker. For example, regarding an MVA liquid crystal, there is a problem of a viewing angle characteristic in that excess brightness occurs when viewing its liquid crystal panel at an oblique angle. However, it is possible to improve the viewing angle characteristic by the time-division driving of the present invention. That is, in the image display apparatus of the present invention, the viewing angle characteristic of the display panel can be controlled by the switching of the display modes.

The following will explain a relation between a change in the luminance distribution ratio for the sub-frames and a change in the viewing angle characteristic. Tables 3 to 5 show three examples, and the luminance distribution for the first-half sub-frame and the second-half sub-frame is different among these examples in such a setting that the input image signal tone level is the same as the luminance of one frame when viewed from the front. In Table 3, the luminance distribution is set such that the luminance of the first-half sub-frame is the same as that of the second-half sub-frame, and the display performance is the same as that of the normal hold driving. Moreover, in Table 4, the luminance distribution is set such that the difference of luminance between the first-half sub-frame and the second-half sub-frame is maximum at each input tone level, and this luminance distribution is such a distribution that the maximum effect of suppressing the unfocused moving image can be obtained. Further, in Table 5, the luminance distribution is such a distribution that the improvement of the viewing angle characteristic is considered.

TABLE 3

| | | | | | One frame | |
|---|---|---|---|---|---|---|
| Input image | | | | | luminance | |
| signal tone | Sub-frame tone level | | Sub-frame luminance | | | Oblique |
| level | First half | Second half | First half | Second half | Front (0°) | (60°) |
| 0.0 | 0.0 | 0.0 | 0.0 | 0.0 | 0.0 | 0.0 |
| 2.1 | 2.1 | 2.1 | 0.0 | 0.0 | 0.0 | 0.4 |
| 10.1 | 10.1 | 10.1 | 0.6 | 0.6 | 0.6 | 7.5 |
| 17.5 | 17.5 | 17.5 | 2.2 | 2.2 | 2.2 | 15.8 |
| 24.7 | 24.7 | 24.7 | 4.6 | 4.6 | 4.6 | 23.1 |
| 32.5 | 32.5 | 32.5 | 8.4 | 8.4 | 8.4 | 30.5 |
| 39.2 | 39.2 | 39.2 | 12.8 | 12.8 | 12.8 | 36.1 |
| 45.0 | 45.0 | 45.0 | 17.3 | 17.3 | 17.3 | 40.4 |
| 50.5 | 50.5 | 50.5 | 22.3 | 22.3 | 22.3 | 44.4 |
| 58.1 | 58.1 | 58.1 | 30.2 | 30.2 | 30.2 | 49.8 |
| 64.7 | 64.7 | 64.7 | 38.4 | 38.4 | 38.4 | 54.6 |
| 70.4 | 70.4 | 70.4 | 46.2 | 46.2 | 46.2 | 58.3 |
| 75.7 | 75.7 | 75.7 | 54.1 | 54.1 | 54.1 | 62.2 |
| 82.7 | 82.7 | 82.7 | 65.9 | 65.9 | 65.9 | 69.6 |
| 88.7 | 88.7 | 88.7 | 76.8 | 76.8 | 76.8 | 77.3 |
| 94.0 | 94.0 | 94.0 | 87.3 | 87.3 | 87.3 | 87.0 |
| 100.0 | 100.0 | 100.0 | 100.0 | 100.0 | 100.0 | 100.0 |

TABLE 4

| | | | | | One frame | |
|---|---|---|---|---|---|---|
| Input image | | | | | luminance | |
| signal tone | Sub-frame tone level | | Sub-frame luminance | | | Oblique |
| level | First half | Second half | First half | Second half | Front (0°) | (60°) |
| 0.0 | 0.0 | 0.0 | 0.0 | 0.0 | 0.0 | 0.0 |
| 2.1 | 0.0 | 2.9 | 0.0 | 0.0 | 0.0 | 0.3 |
| 10.1 | 0.0 | 13.8 | 0.0 | 1.3 | 0.6 | 5.5 |
| 17.5 | 0.0 | 24.0 | 0.0 | 4.3 | 2.2 | 11.1 |
| 24.7 | 0.0 | 33.8 | 0.0 | 9.2 | 4.6 | 15.7 |
| 32.5 | 0.0 | 44.5 | 0.0 | 16.9 | 8.4 | 20.0 |
| 39.2 | 0.0 | 53.8 | 0.0 | 25.5 | 12.8 | 23.3 |
| 45.0 | 0.0 | 61.7 | 0.0 | 34.6 | 17.3 | 26.2 |
| 50.5 | 0.0 | 69.3 | 0.0 | 44.6 | 22.3 | 28.7 |
| 58.1 | 0.0 | 79.6 | 0.0 | 60.5 | 30.2 | 33.1 |
| 64.7 | 0.0 | 88.7 | 0.0 | 76.7 | 38.4 | 39.0 |
| 70.4 | 0.0 | 96.4 | 0.0 | 92.3 | 46.2 | 47.0 |
| 75.7 | 32.2 | 100.0 | 8.3 | 100.0 | 54.1 | 65.1 |
| 82.7 | 59.3 | 100.0 | 31.7 | 100.0 | 65.9 | 75.3 |
| 88.7 | 75.3 | 100.0 | 53.6 | 100.0 | 76.8 | 81.0 |
| 94.0 | 87.5 | 100.0 | 74.5 | 100.0 | 87.3 | 87.9 |
| 100.0 | 100.0 | 100.0 | 100.0 | 100.0 | 100.0 | 100.0 |

TABLE 5

| | | | | | One frame | |
|---|---|---|---|---|---|---|
| Input image | | | | | luminance | |
| signal tone | Sub-frame tone level | | Sub-frame luminance | | | Oblique |
| level | First half | Second half | First half | Second half | Front (0°) | (60°) |
| 0.0 | 0.0 | 0.0 | 0.0 | 0.0 | 0.0 | 0.0 |
| 2.1 | 0.0 | 2.9 | 0.0 | 0.0 | 0.0 | 0.3 |
| 10.1 | 0.0 | 13.8 | 0.0 | 1.3 | 0.6 | 5.5 |
| 17.5 | 0.0 | 24.0 | 0.0 | 4.3 | 2.2 | 11.1 |
| 24.7 | 0.0 | 33.8 | 0.0 | 9.2 | 4.6 | 15.7 |
| 32.5 | 0.0 | 44.5 | 0.0 | 16.9 | 8.4 | 20.0 |
| 39.2 | 0.0 | 53.8 | 0.0 | 25.5 | 12.8 | 23.3 |
| 45.0 | 0.0 | 61.7 | 0.0 | 34.6 | 17.3 | 26.2 |
| 50.5 | 12.3 | 68.5 | 1.0 | 43.6 | 22.3 | 33.2 |
| 58.1 | 27.8 | 75.9 | 6.0 | 54.5 | 30.2 | 44.1 |
| 64.7 | 40.9 | 80.9 | 14.0 | 62.7 | 38.4 | 52.4 |
| 70.4 | 51.3 | 84.7 | 23.0 | 69.3 | 46.2 | 58.4 |
| 75.7 | 59.6 | 88.4 | 32.0 | 76.3 | 54.1 | 63.9 |
| 82.7 | 70.3 | 93.2 | 46.0 | 85.7 | 65.9 | 71.4 |
| 88.7 | 79.3 | 97.0 | 60.0 | 93.6 | 76.8 | 79.4 |
| 94.0 | 87.5 | 100.0 | 74.5 | 100.0 | 87.3 | 87.9 |
| 100.0 | 100.0 | 100.0 | 100.0 | 100.0 | 100.0 | 100.0 |

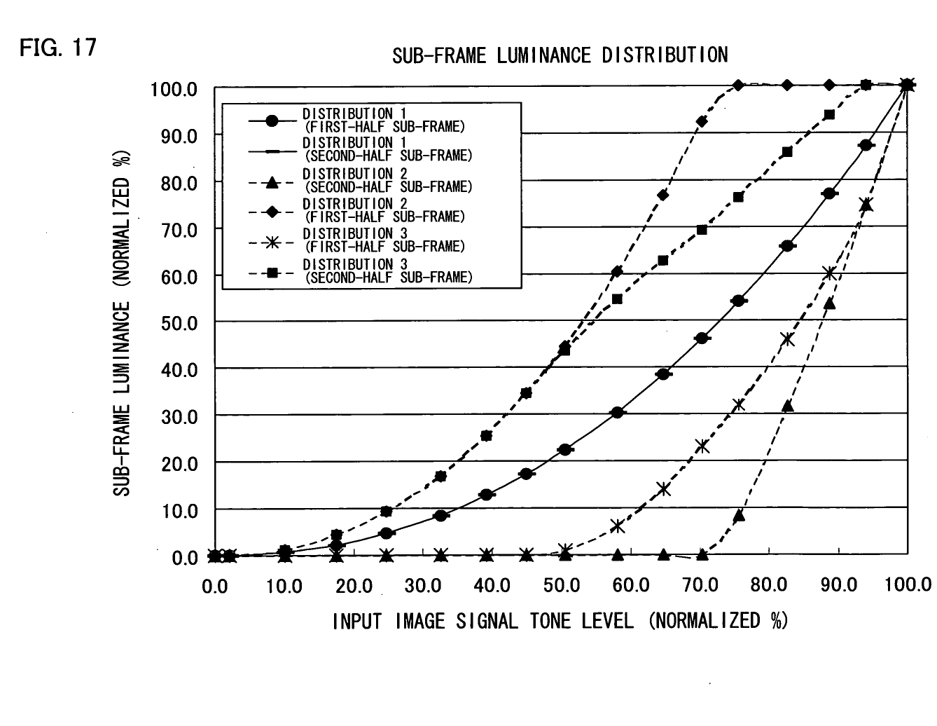

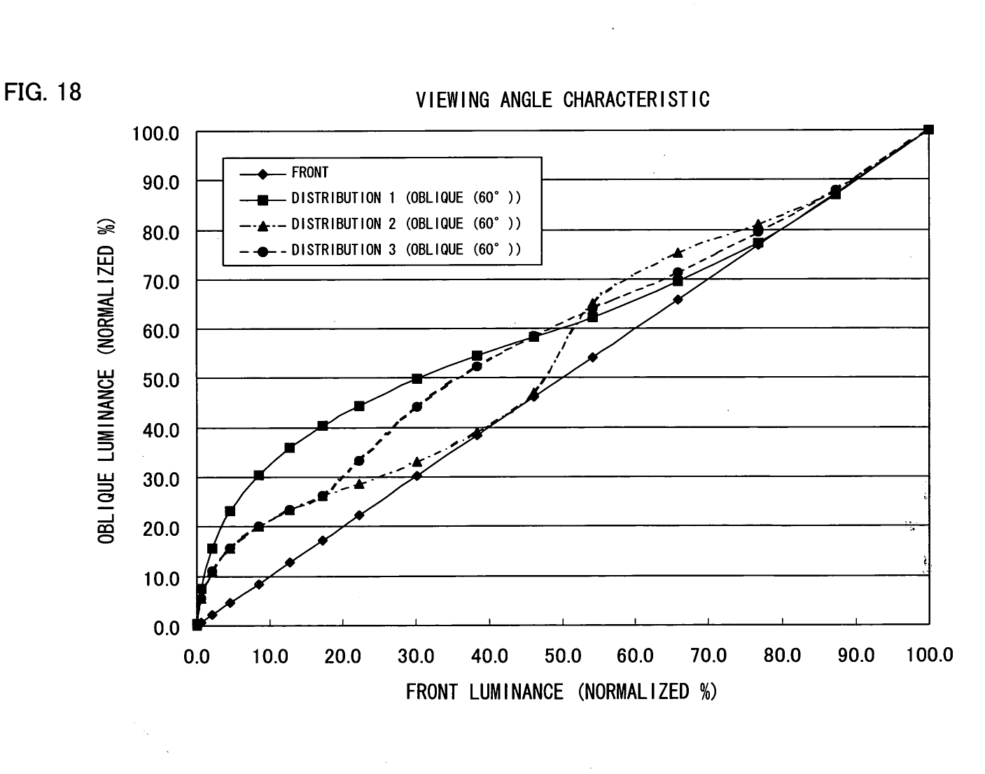

FIG. 17 is a graph showing the distribution ratio for the first-half sub-frame and the second-half sub-frame with respect to the input image signal tone level in the luminance distributions shown in Tables 3 to 5. Moreover, FIG. 18 is a graph showing visible luminance (front luminance) when viewed from the front and visible luminance (oblique luminance) when viewed at an oblique angle of 60° in the display of the luminance distributions shown in Tables 3 to 5. In FIGS. 17 and 18, Distribution 1 corresponds to the luminance distribution shown in Table 3, Distribution 2 corresponds to the luminance distribution shown in Table 4, and Distribution 3 corresponds to the luminance distribution shown in Table 5.

According to FIG. 18, it is recognized that in Distribution 1, the oblique luminance at the oblique angle of 60° is largely different from the front luminance, and the viewing angle characteristic is not so good. In contrast, it is recognized that in Distributions 2 and 3, the difference between the oblique luminance and the front luminance is smaller than that in Distribution 1, and the viewing angle characteristic is improved.

However, in Distribution 2, since the improvement effect of the viewing angle characteristic in a luminance range from 40% to 50% is too large as compared with the other luminance range, the balance of improvement of the viewing angle characteristic with respect to the entire luminance is bad. When the balance of improvement of the viewing angle characteristic is bad as above, there may be a problem in a color display that the coloring changes when viewed at an oblique angle. In Distribution 3, the improvement of the viewing angle characteristic with respect to the entire luminance is balanced as compared with the improvement in Distribution 2, and the luminance distribution here is the most satisfactory in light of the viewing angle characteristic. Thus, it is recognized that the viewing angle characteristic can be controlled by changing the luminance distribution ratio for the sub-frames as above.

That is, the image display apparatus of the present invention is not limited to an apparatus which switches the display modes so as to switch between a mode which gives priority to the display characteristic of the moving image and a mode which gives priority to the suppression of the flicker. The image display apparatus of the present invention may be an apparatus which switches between the mode which gives priority to the display characteristic of the moving image and a mode which gives priority to the viewing angle characteristic. Needless to say, the image display apparatus may have three or more display modes, may be able to control all of the display characteristic of the moving image, the degree of suppression of the flicker, and the viewing angle characteristic, and may be able to optimize the display quality by combining all of these display performances.

If the image display apparatus has the display mode of improving the viewing angle characteristic, this display mode can be realized by setting data, stored in the LUT, in such a manner as above, and this can be realized by the image display apparatus whose circuitry is the same as that in Embodiments 1 to 7.

The image display apparatus in Embodiments 1 to 7 can function as an image display monitor such as a liquid crystal monitor, and can function as a television receiver.

The image display apparatus can function as the image display monitor by including a signal input section (for example, input port) which inputs an externally input image signal to the control LSI. Meanwhile, the image display apparatus can function as the television receiver by including a tuner section. The tuner section selects a channel of a television broadcasting signal, and supplies, to the control LSI, a television image signal of the selected channel as the input image signal.

Moreover, the image display apparatus may be arranged such that switching among the distributing means can be carried out by an externally input operation.

According to the above arrangement, the user can carry out the switching operation of the distributing means, so that it is possible to obtain the display image which is adjusted in light of the unfocused moving image and flicker in accordance with the user's preferences.

Moreover, the image display apparatus may be arranged such that switching among the distributing means is carried out on the basis of the input image signal (for example, the image display apparatus is arranged so as to include determining means for determining the content of the input image on the basis of the input image signal.)

According to the above arrangement, since switching among the distributions is carried out on the basis of the result of the determination of the content of the input image, switching among the distributing means is carried out appropriately without asking the user for troublesome operations.

Moreover, the image display apparatus may be arranged such that whether the input image is the moving image or the still image is determined, and switching among the distributing means is carried out on the basis of the result of the determination (for example, the image display apparatus is arranged so as to include moving/still image determining means for determining whether the input image is the moving image or the still image). At this time, it is preferable that switching among the distributing means be carried out so that the distribution ratio is set such that the difference of luminance between the sub-frames when it is determined that the input image is the still image is smaller than that when it is determined that the input image is the moving image.

According to the above arrangement, an appropriate display mode is selected in accordance with the result of the determination regarding whether the input image is the moving image or the still image. That is, since the time-division driving in the image display apparatus has the effect of suppressing the unfocused moving image, this effect does not work (or this effect is small) when the image display apparatus displays the still image (or a moving image which is like a still image since it includes less movement). Therefore, when the display image is the moving image, the display is carried out by such a distribution ratio that the difference of luminance between the sub-frames is large in light of the effect of suppressing the unfocused moving image, and when the display image is the still image, the display is carried out by such a distribution ratio that the effect of suppressing the unfocused moving image is reduced and the difference of luminance between the sub-frames is small in light of the suppression of the flicker.

Moreover, the image display apparatus may be arranged so that switching among the distributing means is carried out on the basis of the average luminance of the input image (for example, the image display apparatus is arranged so as to include luminance measuring means for measuring the average luminance of the input image) At this time, it is preferable that switching among the distributing means is carried out by the switching means so that the distribution ratio is set such that the difference of luminance between the sub-frames when it is determined that the average luminance of the input image is high is smaller than that when it is determined that the average luminance of the input image is low.

According to the above arrangement, the average luminance of the input image is measured, and an appropriate display mode is selected on the basis of the result of the measurement. That is, in the time-division driving of the image display apparatus, generally, the flicker tends to occur when the luminance of the display image is high, and the flicker hardly occurs when the luminance of the display image is low. Therefore, when the luminance of the display image is low, the display is carried out by such a distribution ratio that the difference of luminance between the sub-frames is large in light of the effect of suppressing the unfocused moving image, and when the luminance of the display image is high, the display is carried out by such a distribution ratio that the effect of suppressing the unfocused moving image is reduced and the difference of luminance between the sub-frames is small in light of the suppression of the flicker.

Moreover, the image display apparatus may be arranged so that switching among the distributing means is carried out on the basis of the frame frequency of the input image (for example, the image display apparatus is arranged so as to include frame frequency measuring means for measuring the frame frequency of the input image). At this time, it is preferable that switching among the distribution means is carried out by the switching means so that the distribution ratio is set such that the difference of luminance between the sub-frames when it is determined that the frame frequency of the input image is low is smaller than that when it is determined that the frame frequency of the input image is high.

According to the above arrangement, the frame frequency of the input image is measured, and an appropriate display mode is selected on the basis of the result of the measurement. That is, in the time-division driving of the image display apparatus, generally, the flicker hardly occurs when the frame frequency is high, and the flicker tends to occur when the frame frequency is low. Therefore, when the luminance frame frequency of the display image is high, the display is carried out by such a distribution ratio that the difference of luminance between the sub-frames is large in light of the effect of suppressing the unfocused moving image, and when the frame frequency of the display image is low, the display is carried out by such a distribution ratio that the effect of suppressing the unfocused moving image is reduced and the difference of luminance between the sub-frames is small in light of the suppression of the flicker

Moreover, in the image display apparatus, it is preferable that the switching means have a threshold value set between 50 Hz and 60 Hz as a threshold value of the frame frequency that is a standard for switching among the distributing means.

According to the above arrangement, switching among the distributing means, that is, the switching of the luminance distribution ratio can be carried out between the frame frequency (PAL) of 50 Hz and the frame frequency (NTSC) of 60 Hz which are generally used as a signal of a television image.

Moreover, the image display apparatus may be arranged so that switching among the distributing means is carried out on the basis of an input source of the input image (for example, the image display apparatus is arranged so as to include image source determining means for determining the input source of the input image).

According to the above arrangement, the input source of the input image is determined, and an appropriate display mode is selected on the basis of the result of the determination. That is, many of recent image display apparatuses are arranged so that the image signal can be supplied from various image sources, such as personal computers, television tuners, videos and games. The characteristic (especially, the characteristic of the moving image) of the image signal to be supplied can be defined to some extent depending on the image source.

Therefore, in the image display apparatus, it is possible that (i) when the image source is determined, and for example, the image source is a source (for example, a personal computer) which supplies an image whose moving image characteristic is low, the display is carried out by such a distribution ratio that the effect of suppressing the unfocused moving image is reduced and the difference of luminance between the sub-frames is small in light of the suppression of the flicker, and (ii) when the image source is a source which supplies an image whose moving image characteristic is high, the display is carried out by such a distribution ratio that the difference of luminance between the sub-frames is large in light of the effect of suppressing the unfocused moving image.

Moreover, the image display apparatus may be arranged so that the content of the input image is determined for each pixel on the basis of the input image signal, and switching among the distributing means for each pixel is carried out on the basis of the result of this determination, or may be arranged so that the content of the input image is determined for each of plural divided areas on the basis of the input image signal, and switching among the distributing means for each of the plural divided areas is carried out on the basis of the result of this determination.

Moreover, the image display apparatus may be arranged so that (i) whether the input image is the still image or the moving image is determined for each of plural divided areas, and (ii) switching among the distributing means is carried out so that the distribution ratio is set such that the difference of luminance between the sub-frames in the area where it is determined that the input image is the still image is smaller than that in the area where it is determined that the input image is the moving image.

Alternatively, the image display apparatus may be arranged so that (i) the luminance of the input image is measured for each of plural divided areas, and (ii) switching among the distributing means is carried out so that the distribution ratio is set such that the difference of luminance between the sub-frames in the area where it is determined that the average luminance of the input image is high is smaller than that in the area where it is determined that the average luminance of the input image is low.

According to the above arrangement, for example, it is possible to carry out such a display control that (i) the moving/still image determining means determines, in the input image, the area (moving image area) where the moving image is displayed and the area (still image area) where the still image is displayed, (ii) in the moving image area, the display is carried out in light of the effect of suppressing the unfocused moving image, and (iii) in the still image area, the display is carried out in light of the suppression of the flicker, and the effect of suppressing the unfocused moving image is reduced.

Alternatively, it is possible to carry out such a display control that (i) the luminance measuring means determines, in the input image, the area (low luminance area) where the luminance of the display image is low and the area (high luminance area) where the luminance of the display image is high, (ii) in the low luminance area, the display is carried out in light of the effect of suppressing the unfocused moving image, and (iii) in the high luminance area, the display is carried out in light of the suppression of the flicker, and the effect of suppressing the unfocused moving image is reduced.

Moreover, by combining the image display apparatus with a signal input section which transfers an externally input image signal to the image display apparatus, it is possible to constitute a liquid crystal monitor used for a personal computer, etc.

Moreover, by combining the image display apparatus with a tuner section, it is possible to constitute a liquid crystal television receiver.

### INDUSTRIAL APPLICABILITY

An image display apparatus which carries out time-division driving to suppress an unfocused moving image can reduce a flicker, and the present invention is applicable to an image display apparatus which uses a hold display element, such as a liquid crystal display element or an EL display element.

1. An image display apparatus which divides one frame period of an input image signal into a plurality of sub-frame periods so as to carry out image display, the image display apparatus comprising:
a plurality of distributing means for distributing luminance to respective sub-frames so that a total of time integral values of luminance of the respective sub-frames in said one frame period reproduces luminance of said one frame period based on the input image signal,
among the plurality of distributing means, a luminance distribution ratio for the sub-frames being different, and
switching among the plurality of distributing means being carried out.

2. The image display apparatus as set forth in claim 1, further comprising switching means for switching among the plurality of distributing means.

3. The image display apparatus as set forth in claim 1, wherein switching among the distributing means is able to be carried out by an externally input operation.

4. The image display apparatus as set forth in claim 1, wherein switching among the distributing means is carried out on the basis of the input image signal.

5. The image display apparatus as set forth in claim 4, further comprising determining means for determining a content of an input image on the basis of the input image signal.

6. The image display apparatus as set forth in claim 4, wherein whether an input image is a moving image or a still image is determined, and switching among the distributing means is carried out on the basis of a result of this determination.

7. The image display apparatus as set forth in claim 5, wherein switching among the distributing means is carried out so that the distribution ratio is set such that a difference of luminance between the sub-frames when it is determined that the input image is a still image is smaller than that when it is determined that the input image is a moving image.

8. The image display apparatus as set forth in claim 5, further comprising moving/still image determining means for determining whether the input image is a moving image or a still image.

9. The image display apparatus as set forth in claim 4, wherein switching among the distributing means is carried out on the basis of an average luminance of an input image.

10. The image display apparatus as set forth in claim 9, wherein switching among the distributing means is carried out so that the distribution ratio is set such that a difference of luminance between the sub-frames when it is determined that the average luminance of the input image is high is smaller than that when it is determined that the average luminance of the input image is low.

11. The image display apparatus as set forth in claim 4, further comprising luminance measuring means for measuring an average luminance of an input image.

12. The image display apparatus as set forth in claim 4, wherein switching among the distributing means is carried out on the basis of a frame frequency of an input image.

13. The image display apparatus as set forth in claim 12, wherein switching among the distributing means is carried out so that the distribution ratio is set such that a difference of luminance between the sub-frames when it is determined that the frame frequency of the input image is low is smaller than that when it is determined that the frame frequency of the input image is high.

14. The image display apparatus as set forth in claim 13, wherein a threshold value set between 50 Hz and 60 Hz is included as a threshold value of the frame frequency that is a standard for switching among the distributing means.

15. The image display apparatus as set forth in claim 4, further comprising frame frequency measuring means for measuring a frame frequency of an input image.

16. The image display apparatus as set forth in claim 1, wherein switching among the distributing means is carried out on the basis of an input source of an input image.

17. The image display apparatus as set forth in claim 16, further comprising image source determining means for determining the input source of the input image.

18. The image display apparatus as set forth in claim 1, wherein the content of the input image is determined for each pixel on the basis of the input image signal, and switching among the distributing means for each pixel is carried out on the basis of a result of this determination.

19. The image display apparatus as set forth in claim 1, wherein the content of the input image is determined for each of plural divided areas on the basis of the input image signal, and switching among the distributing means for each of the plural divided areas is carried out on the basis of a result of this determination.

20. The image display apparatus as set forth in claim 19, wherein:
whether the input image is the still image or the moving image is determined for each of the plural divided areas; and
switching among the distributing means is carried out so that the distribution ratio is set such that the difference of luminance between the sub-frames in the area where it is determined that the input image is the still image is smaller than that in the area where it is determined that the input image is the moving image.

21. The image display apparatus as set forth in claim 19, wherein:
the luminance of the input image is measured for each of the plural divided areas; and
switching among the distributing means is carried out so that the distribution ratio is set such that the difference of luminance between the sub-frames in the area where it is determined that the average luminance of the input image is high is smaller than that in the area where it is determined that the average luminance of the input image is low.

22. The image display apparatus as set forth in claim 1, wherein switching among the distributing means switches a display performance of a moving image.

23. The image display apparatus as set forth in claim 1, wherein switching among the distributing means switches a degree of occurrence of a flicker.

24. The image display apparatus as set forth in claim 1, wherein switching among the distributing means switches a viewing angle characteristic.

25. The image display apparatus as set forth in claim 1, wherein switching among the distributing means by the switching means optimizes a display quality by combining two or more of a display performance of a moving image, a degree of occurrence of a flicker and a viewing angle characteristic.

26. An image display monitor, comprising:
the image display apparatus as set forth in claim 1; and
a signal input section which transfers an externally input image signal to the image display apparatus.

27. A television receiver,
comprising the image display apparatus as set forth in claim 1.
